(19) United States
(12) Patent Application Publication
(10) Pub. No.: US 2022/0197161 A1
(43) Pub. Date: Jun. 23, 2022

(54) ELECTROPHOTOGRAPHIC PHOTOCONDUCTOR, METHOD OF MANUFACTURING THE SAME, AND ELECTROPHOTOGRAPHIC EQUIPMENT

(71) Applicant: FUJI ELECTRIC CO., LTD., Kawasaki-shi (JP)

(72) Inventors: Seizo KITAGAWA, Matsumoto-city (JP); Shinjiro SUZUKI, Matsumoto-city (JP); Hiroshi EMORI, Shenzhen (CN); Kazuki NEBASHI, Matsumoto-city (JP)

(73) Assignee: FUJI ELECTRIC CO., LTD., Kawasaki-shi (JP)

(21) Appl. No.: 17/548,368

(22) Filed: Dec. 10, 2021

(30) Foreign Application Priority Data
Dec. 21, 2020 (JP) 2020-211737
Sep. 27, 2021 (JP) 2021-157137

(51) Int. Cl. G03G 5/06

(52) U.S. Cl. CPC G03G 5/0677

(57) ABSTRACT

Provided are a photoconductor for electrophotography that has sufficiently high sensitivity and excellent potential stability during repeated printing in various environments, and does not cause problems, such as deterioration of gradation or generation of memory images, especially when applied to monochrome high-speed printers and small medium-speed tandem color printers, as well as a method of manufacturing the photoconductor for electrophotography, and an electrophotographic equipment. The positively-charged photoconductor for electrophotography includes a conductive substrate; and a photosensitive layer formed on the conductive substrate, in which the photosensitive layer contains electron transport materials, and at least one of the electron transport materials contains an azoquinone derivative having a structure represented by general formula (ET1) below:

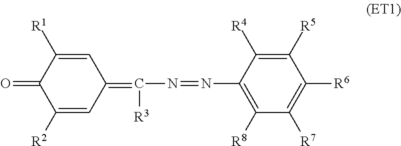

### CROSS-REFERENCE TO RELATED APPLICATIONS

This application claims priority from Japanese Patent Application No. 2020-211737, filed on Dec. 21, 2020, and from Japanese Patent Application No. 2021-157137, filed on Sep. 27, 2021. The contents of the applications are incorporated herein by reference.

### TECHNICAL FIELD

The present invention relates to a photoconductor for electrophotography (hereinafter, also referred to as simply “photoconductor”) used in electrophotographic printers, copiers, facsimiles, and the like, a method of manufacturing the same, and an electrophotographic equipment.

### BACKGROUND ART

A photoconductor for electrophotography has a basic structure containing a photosensitive layer with a photoconductive function formed on a conductive substrate. Recently, organic photoconductors for electrophotography using organic compounds as components serving to generate and transport electric charges have been actively researched and developed in view of their advantages such as diversity of materials, high productivity and safety, and therefore have been increasingly applied to copiers, printers, and the like.

In general, a photoconductor needs to have functions to hold surface charge in the dark, to accept light and generate charge, and to transport generated charge. A photosensitive layer plays the roles. Photoconductors are classified into single-layer photoconductors and multi-layer (functionally separated) photoconductors, depending on the aspect of the photosensitive layer. A single-layer photoconductor includes a single-layer photosensitive layer that has both charge generation and charge transport functions. A multi-layer photoconductor includes a photosensitive layer with a charge generation layer and a charge transport layer stacked. The charge generation layer is mainly responsible for the charge generation function when receiving light. The charge transport layer is responsible for retaining the surface charge in dark areas and transporting the charge generated in the charge generation layer during light reception.

There are two types of photoconductors: positively charged photoconductors, in which the surface of the photoconductor is positively charged, and negatively charged photoconductors, in which the surface of the photoconductor is negatively charged. In positively charged photoconductors, an electron transport material with electron transport capability is used as a charge transport material that constitutes the photosensitive layer. As such electron transport materials, azoquinone derivatives having one chlorine atom in the para position as a substituent are widely used (see Patent Documents 1 to 3).

However, the use of an azoquinone derivative having the above specific structure tends to result in insufficient electrical potential stability, especially when repeatedly used in low-temperature and low-humidity environments, which causes, for example, ghost images and character thickening phenomena, making it difficult to stably obtain good images.

To address this problem, it has been proposed to use a combination of an azoquinone derivative having the above specific structure and other electron transport materials (see Patent Document 4).

Other conventional arts pertaining to the combined use of electron transport materials in photoconductors includes, for example, the technology described in Patent Document 5.

On the other hand, a high-sensitivity photoconductor is required for monochrome high-speed printers and small medium-speed tandem color printers. Conventional arts pertaining to photoconductors applicable to monochrome high-speed machines and tandem color machines with high image quality (e.g., about 40 ppm or higher with A4 paper) include, for example, the technology described in Patent Document 6.

### RELATED ART DOCUMENTS

### Patent Documents

Patent Document 1: JP2000-199979A
Patent Document 2: WO2009/104571A1
Patent Document 3: WO2019/159342A1
Patent Document 4: WO2019/142342A1
Patent Document 5: JP2018-105972A
Patent Document 6: WO2018/154740A

### SUMMARY OF THE INVENTION

### Problems to be Solved by the Invention

However, even in the case where an azoquinone derivative having the specific structure as described above and another electron transport material are used in combination, it has only resulted in relatively good stability in repeated use, but not simultaneously in sufficient high-sensitivity characteristics. For this reason, repeated printing in various environments may have resulted in insufficient potential stability, and problems such as deterioration of gradation or generation of memory images.

Accordingly, an object of the present invention is to provide a photoconductor for electrophotography that has sufficiently high sensitivity and excellent potential stability during repeated printing in various environments, and does not cause problems such as deterioration of gradation or generation of memory images, especially when applied to monochrome high-speed printers, small medium-speed tandem color printers, and the like, as well as a method of manufacturing the photoconductor for electrophotography, and an electrophotographic equipment.

### Means for Solving the Problems

The present inventors have intensively studied to find that the above problems can be solved by using an azoquinone derivative having a specific structure different from conventionally used ones as an electron transport material, thereby completing the present invention.

Accordingly, a first aspect of the present invention is a positively charged photoconductor for electrophotography including:

a conductive substrate; and

a photosensitive layer formed on the conductive substrate,

wherein the photosensitive layer contains electron transport materials, and

wherein at least one of the electron transport materials contains an azoquinone derivative having a structure represented by the following general formula (ET1):

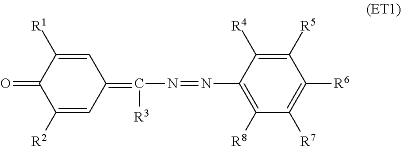

wherein,

R¹ and R² are the same or different and each represent a hydrogen atom, a C₁₋₁₂ alkyl group, a C₁₋₁₂ alkoxy group, an optionally substituted aryl group, a cycloalkyl group, an optionally substituted aralkyl group, or a halogenated alkyl group;

R³ represents a hydrogen atom, a C₁₋₆ alkyl group, a C₁₋₆ alkoxy group, an optionally substituted aryl group, a cycloalkyl group, an optionally substituted aralkyl group, or a halogenated alkyl group;

at least two of R⁴ to R⁸ represent chlorine atoms; and the remaining R⁴ to R⁸ other than those representing chlorine atoms are the same or different, and each represent a hydrogen atom, a halogen atom other than chlorine atom, a C₁₋₁₂ alkyl group, a C₁₋₁₂ alkoxy group, an optionally substituted aryl group, an optionally substituted aralkyl group, an optionally substituted phenoxy group, a halogenated alkyl group, a cyano group, or a nitro group; and

the substituent represents a halogen atom, a C₁₋₆ alkyl group, a C₁₋₆ alkoxy group, a hydroxy group, a cyano group, an amino group, a nitro group, or a halogenated alkyl group.

In a preferred embodiment, the azoquinone derivative having a structure represented by the above general formula (ET1) is such that at least one of R⁴ and R⁸ is a chlorine atom. In another preferred embodiment, the azoquinone derivative having a structure represented by the above general formula (ET1) is such that R¹ and R² are tert-butyl groups, and R³ is a hydrogen atom.

The solubility S_{ETM} (THF) of the azoquinone derivative having a structure represented by the general formula (ET1) (the mass (g) of tetrahydrofuran required to dissolve 1 g of the azoquinone derivative) preferably satisfies the following inequality:

S_{ETM}(THF)≤2.0.

The azoquinone derivative having a structure represented by the general formula (ET1) is preferably represented by the following structural formula (ET1-4) or (ET1-5):

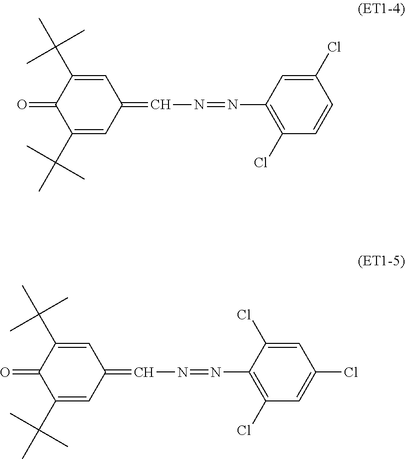

The electron transport materials preferably further contain a naphthalenetetracarboxdiimide compound having a structure represented by the following general formula (ET2):

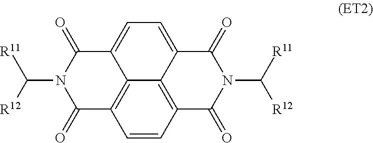

wherein, R¹¹ and R¹² are the same or different and each represent a hydrogen atom, a C₁₋₁₀ alkyl group, an alkylene group, an alkoxy group, an alkyl ester group, an optionally substituted phenyl group, an optionally substituted naphthyl group, or a halogen atom, and R¹¹ and R¹² are optionally linked together to form an optionally substituted aromatic ring.

The electron transport materials preferably further contain a compound having a structure represented by the following structural formula (ET-1):

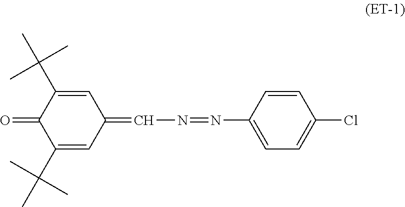 [SMILES: CC(C)(C)C1=CC(=CN=Nc2ccc(Cl)cc2)C=C(C(C)(C)C)C1=O]

The photosensitive layer is a multi-layer type including, in sequence, a charge transport layer and a charge generation layer, and the charge generation layer can contain the electron transport materials. The photosensitive layer can also be a single-layer type including the electron transport materials.

A second aspect of the present invention is a method of manufacturing the photoconductor for electrophotography, including the steps of:

preparing a photosensitive layer coating solution containing an azoquinone derivative having a structure represented by the general formula (ET1); and

forming the photosensitive layer by dip coating using the photosensitive layer coating solution.

A third aspect of the present invention is an electrophotographic equipment on which the photoconductor for electrophotography is mounted.

### Effects of the Invention

According to the present invention, a photoconductor for electrophotography that has sufficiently high sensitivity and excellent potential stability during repeated printing in various environments, and does not cause problems such as deterioration of gradation or generation of memory images, especially when applied to monochrome high-speed printers, small medium-speed tandem color printers, and the like, as well as a method of manufacturing the photoconductor for electrophotography, and an electrophotographic equipment can be provided.

### BRIEF DESCRIPTION OF THE DRAWINGS

FIG. 1 is a schematic cross-sectional view showing a photoconductor for electrophotography according to an exemplary embodiment of the present invention.

FIG. 2 is a schematic cross-sectional view showing a photoconductor for electrophotography according to another embodiment of the present invention.

FIG. 3 is a schematic configuration showing an electrophotographic equipment according to an exemplary embodiment of the present invention.

### MODE FOR CARRYING OUT THE INVENTION

Photoconductors for electrophotography according to specific embodiments of the present invention will be described in detail with reference to the drawings. However, the present invention is not limited to the description below.

FIG. 1 is a schematic cross-sectional view of a photoconductor for electrophotography according to an exemplary embodiment of the present invention, showing a positively charged single-layer photoconductor for electrophotography. As shown in the figure, the positively charged single-layer photoconductor includes a conductive substrate 1, on which an undercoat layer 2 and a single-layer positively charged photosensitive layer (single-layer photosensitive layer) 3 having both charge generation function and charge transport function are stacked in sequence.

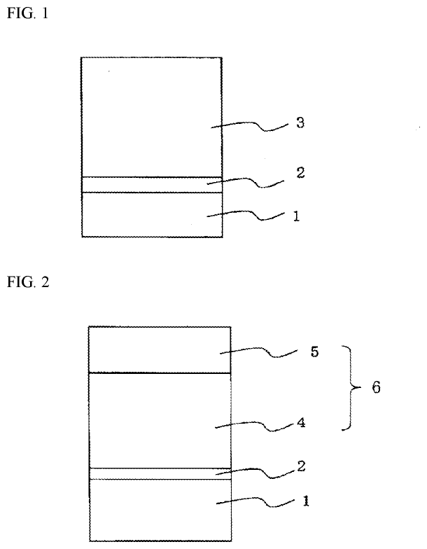

FIG. 2 is a schematic cross-sectional view of a photoconductor for electrophotography according to another exemplary embodiment of the present invention, showing a positively charged multi-layer photoconductor for electrophotography. As shown in the figure, the positively charged multi-layer photoconductor includes a multi-layer positively charged photosensitive layer 6. The photosensitive layer 6 includes a charge transport layer 4 with charge transport function and a charge generation layer 5 with charge generation function, which are stacked in sequence on a cylindrical conductive substrate 1 via an undercoat layer 2. The undercoat layer 2 may be formed as necessary in the photoconductor in both FIGS. 1 and 2. Although not shown, a surface protection layer can also be formed on the top surface of the photoconductor in both FIGS. 1 and 2.

In embodiments of the present invention, the photosensitive layer in the photoconductor contains electron transport materials, wherein at least one of the electron transport materials contains an azoquinone derivative having a structure represented by the following general formula (ET1). Unlike azoquinone derivatives that have been conventionally used and have one chlorine atom in the para position as a substituent, the azoquinone derivative having a structure represented by the following general formula (ET1) has two or more soluble chlorine atoms as substituents. It is believed that the use of such an azoquinone derivative as an electron transport material allows for improving the solubility to solvents and the compatibility to resins, so that the content of the electron transport materials in the photosensitive layer can be increased, and that dispersion of the electron transport materials with sharp particle size distribution can be achieved. This allows for achieving both sufficient high-sensitivity characteristics and potential stability in repeated use in various environments and obtaining a photoconductor that provides stable and good image quality even when applied to monochrome high-speed printers and small medium-speed tandem color printers. In addition, there are no problems such as deterioration of gradation or generation of memory images. Also, image defects caused by sebaceous cracks or mineral oil contamination can be avoided.

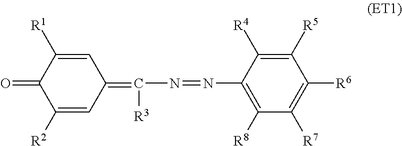

In the formula (ET1), R¹ and R² are the same or different, and each represent a hydrogen atom, a C₁₋₁₂ alkyl group, a C₁₋₁₂ alkoxy group, an optionally substituted aryl group, a cycloalkyl group, an optionally substituted aralkyl group, or a halogenated alkyl group. R³ represents a hydrogen atom, a C₁₋₆ alkyl group, a C₁₋₆ alkoxy group, an optionally substituted aryl group, a cycloalkyl group, an optionally substituted aralkyl group, or a halogenated alkyl group. At least two of R⁴ to R⁸ represent chlorine atoms; and the remaining R⁴ to R⁸ other than those representing chlorine atoms are the same or different, and each represent a hydrogen atom, a halogen atom other than chlorine atom, a C₁₋₁₂ alkyl group, a C₁₋₁₂ alkoxy group, an optionally substituted aryl group, an optionally substituted aralkyl group, an optionally substituted phenoxy group, a halogenated alkyl group, a cyano group, or a nitro group. The substituent represents a halogen atom, a C₁₋₆ alkyl group, a C₁₋₆ alkoxy group, a hydroxy group, a cyano group, an amino group, a nitro group, or a halogenated alkyl group.

Specific examples of the azoquinone derivative having a structure represented by the above general formula (ET1) as the electron transport material include, but are not limited to, the followings. Such an azoquinone derivative can be manufactured by, for example, a method as described in the paragraph [0021] in JP2000-199979A (column 6, lines 4 to 10 in U.S. Pat. No. 6,268,095B1).

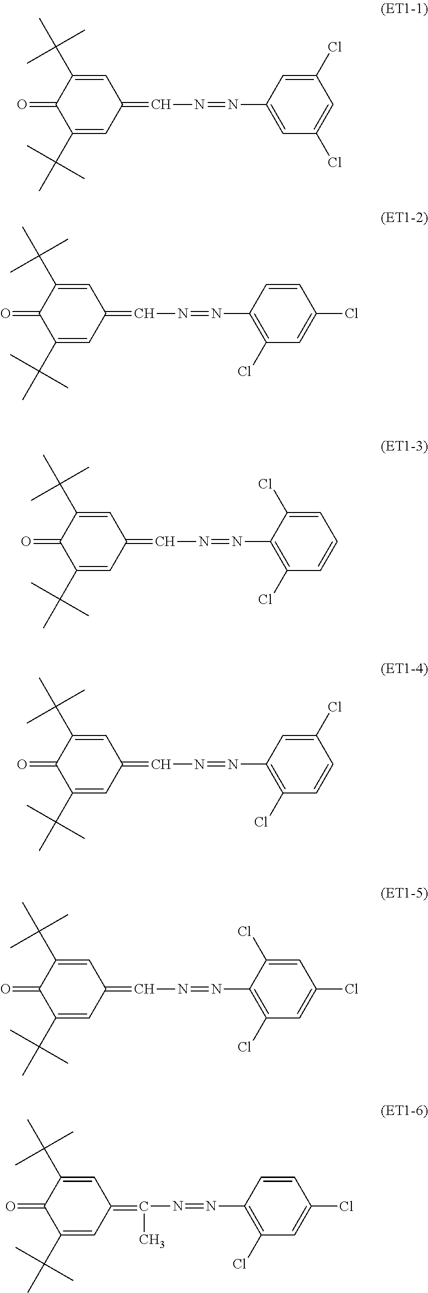

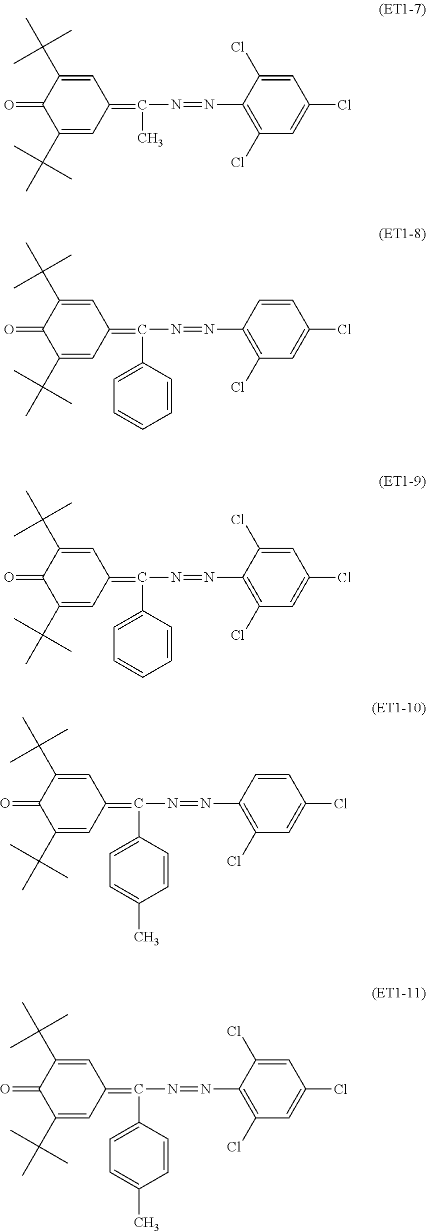

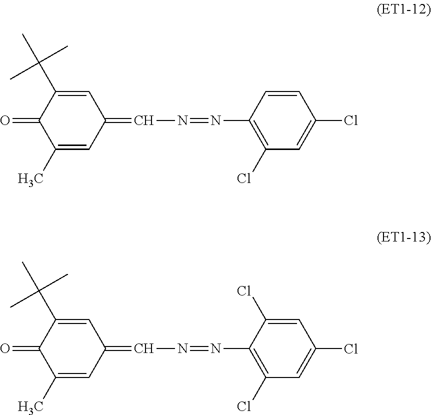

In a preferred embodiment, the azoquinone derivative having a structure represented by the above general formula (ET1) is such that at least one of R⁴ and R⁸ is a chlorine atom. The use of an azoquinone derivative having two or more chlorine atoms as substituents and having such a specific structure allows for obtaining a photoconductor that is superior in terms of sensitivity, potential stability in repeated use, gradation, and generation of memory images. In another preferred embodiment, the azoquinone derivative having a structure represented by the above general formula (ET1) is such that R¹ and R² are tert-butyl groups, and R³ is a hydrogen atom. In a more preferred embodiment, the azoquinone derivative having a structure represented by the above general formula (ET1) is represented by the above structural formula (ET1-4) or (ET1-5). Since the azoquinone derivative represented by the above structural formula (ET1-4) or (ET1-5) is excellent in solubility and electrical characteristics, the azoquinone derivative as an electron transport material can be used to increase the content of electron transport materials in the photosensitive layer. This is particularly advantageous in positively charged multi-layer photoconductors in which a higher content of electron transport materials is required to achieve higher performance. Furthermore, for unknown reasons, an azoquinone compound represented by the above structural formula (ET1-4) is more suitable in terms of sensitivity profiles.

The reason is unclear why the azoquinone derivative having a structure represented by the above structural formula (ET1-4) has excellent solubility as compared with other azoquinone derivatives having one or two chlorine atoms, but this may be due to the effect of the balance between steric hindrance and symmetry in the molecular structure. The possible reason why the azoquinone derivative having a structure represented by the above structural formula (ET1-4) has excellent electrical properties is that it has both excellent dispersibility (solubility) in the film due to its high solubility and excellent electron transport performance due to its possession of two chlorine atoms that serve as electron-withdrawing groups. The azoquinone derivative having a structure represented by the above structural formula (ET1-4) can be well dissolved in the film at more than 40% by mass even when used alone, for example, in a multi-layer positively charged organic photoconductor. This allows for achieving high sensitivity (low exposure area potential) and ghostless high-quality images with excellent gradation, even when used in apparatus with a short exposure-development time of 60 ms or shorter, such as high-speed monochrome apparatus with φ30 drum and A4 vertical feed of 50 ppm or more and medium- to high-speed tandem color apparatus with φ24 drum and A4 vertical feed of 24 ppm or more.

The azoquinone derivative having a structure represented by the above structural formula (ET1-5) can be used in high content, in consideration of excellent electron transport performance due to its possession of three chlorine atoms that serve as electron-withdrawing groups, and good solubility possibly due to the balance between steric hindrance and symmetry in the molecular structure, as compared with other azoquinone derivatives having one or two chlorine atoms. Thus, similar to the azoquinone derivative having a structure represented by the above structural formula (ET1-4), the azoquinone derivative having a structure represented by the above structural formula (ET1-5), when contained in a high amount, especially in a charge generation layer of a multi-layer positively charged organic photoconductor that requires the use of a large amount of electron transport materials, provides clear improvement in performance in high-speed monochrome apparatus and medium- to high-speed tandem color apparatus with a short exposure-development time as described above, as compared with the case where other electron transport materials are used.

For the azoquinone derivative having a structure represented by the general formula (ET1) in a preferred embodiment, the solubility S_{ETM} (THF), as represented by the mass (g) of tetrahydrofuran required to dissolve 1 g of the electron transport materials), of the electron transport materials also satisfies the following inequality:

S_{ETM}(THF)≤2.0.

The use of such an azoquinone derivative ensures good solubility. In a more preferred embodiment, the solubility S_{ETM} (THF) of the azoquinone derivative as an electron transport material satisfies the following inequality:

0.5≤S_{ETM}(THF)≤2.0.

In embodiments of the present invention, the electron transport materials contained in the photosensitive layer of the photoconductor may further contain another electron transport material, in addition to the azoquinone derivative having a structure represented by the general formula (ET1) as described above.

Examples of such another electron transport material include, but are not limited to, succinic anhydride, maleic anhydride, dibromosuccinic anhydride, phthalic anhydride, 3-nitrophthalic anhydride, 4-nitrophthalic anhydride, pyromellitic dianhydride, pyromellitic acid, trimellitic acid, trimellitic anhydride, phthalimide, 4-nitrophthalimide, tetracyanoethylene, tetracyanoquinodimethane, chloranil, bromanil, o-nitrobenzoic acid, malononitrile, trinitrofluorenone, trinitrothioxanthone, dinitrobenzene, dinitroanthracene, dinitroacridine, nitroanthraquinone, dinitroanthraquinone, a thiopyran compound, a quinone compound, a benzoquinone compound, a diphenoquinone compound, a naphthoquinone compound, an anthraquinone compound, a stilbenequinone compound, an azoquinone compound other than the azoquinone derivative having the specific structure as described above, and a naphthalenetetracarboxdiimide compound.

In an especially preferred embodiment, such another electron transport material to be used has an electron mobility of 15×10⁻⁸ [cm²/V·s] or more, and particularly preferably 17×10⁻⁸ to 35×10⁻⁸ [cm²/V·s] when the electric field strength is 20 V/μm. The electron mobility can be measured using a coating solution obtained by adding an electron transport material to a resin binder so that the content of the electron transport material is 50% by mass. The ratio of the electron transport material to the resin binder is 50:50. The resin binder may be a bisphenol Z-polycarbonate resin. For example, lupizeta PCZ-500 (product name, MITSUBISHI GAS CHEMICAL COMPANY, INC.) may be used. Specifically, the coating solution is applied on a substrate and dried at 120° C. for 30 minutes to prepare a coated film having a thickness of 7 μm. Then, the TOF (Time of Flight) method can be used to measure the electron mobility at a constant electric field strength of 20 V/μm. The measurement temperature is 300 K.

In an especially preferred embodiment, another electron transport material to be used in combination with the azoquinone derivative having a structure represented by the general formula (ET1) described above is a naphthalenetetracarboxdiimide compound having a structure represented by the general formula (ET2) below, or a compound having a structure represented by the structural formula (ET-1) below. The use of these electron transport materials in appropriate combinations may facilitate the improvement of the resistance of the photoconductor surface to contamination from surrounding materials and the adjustment of sensitivity properties when matching with the equipment or processes.

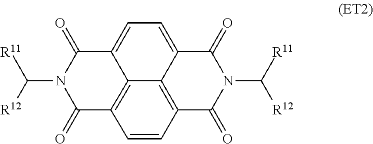

In the formula (ET2), R¹¹ and R¹² are the same or different and each represent a hydrogen atom, a C₁₋₁₀ alkyl group, an alkylene group, an alkoxy group, an alkyl ester group, an optionally substituted phenyl group, an optionally substituted naphthyl group, or a halogen atom, and R¹¹ and R¹² may be linked together to form an optionally substituted aromatic ring.

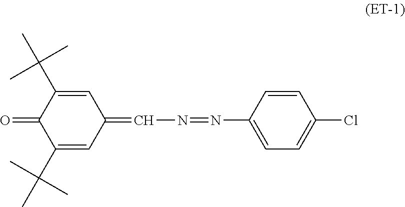 [SMILES: CC(C)(C)C1=CC(=CN=Nc2ccc(Cl)cc2)C=C(C(C)(C)C)C1=O]

Specific examples of the naphthalenetetracarboxdiimide compound having a structure represented by the above general formula (ET2) include the following.

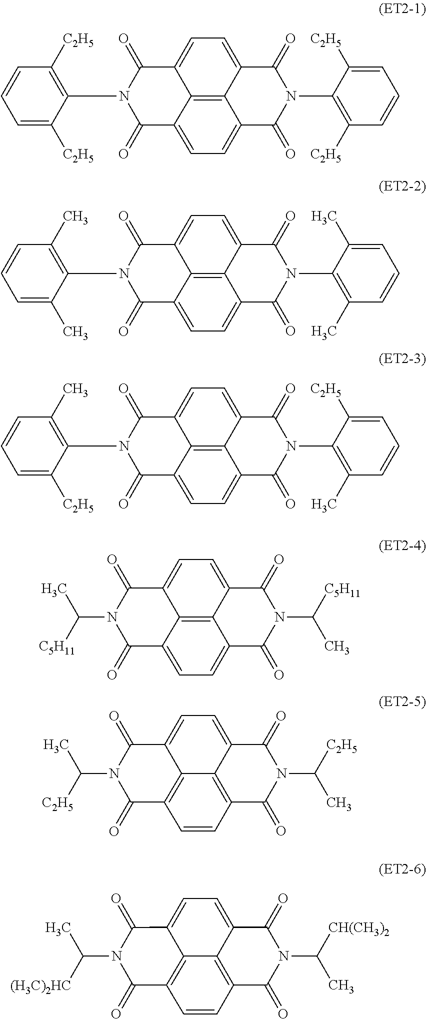

In the case where a combination of an azoquinone derivative having a structure represented by the above general formula (ET1) and a naphthalenetetracarboxdiimide compound having a structure represented by the above general formula (ET2) are used as the electron transport materials, the mass ratio ET1:ET2 is suitably from 5:95 to 95:5, more suitably from 20:80 to 80:20. In the case where a combination of an azoquinone derivative having a structure represented by the above general formula (ET1) and a compound having a structure represented by the above structural formula (ET-1) are used as the electron transport materials, the mass ratio ET1:ET-1 is suitably from 5:95 to 95:5, more suitably from 20:80 to 80:20. Too small amount of the azoquinone derivative having a structure represented by the above general formula (ET1) may tend to cause problems such as deterioration of gradation and memory generation, while too large amount of the azoquinone derivative having a structure represented by the above general formula (ET1) may cause deterioration of the solvent resistance of the photoconductor.

As described above, in embodiments of the present invention, electron transport materials contained in the photosensitive layer of the photoconductor satisfy the conditions described above. In embodiments of the present invention, the photoconductor has such a layer structure as a positively charged single-layer photoconductor for electrophotography shown in FIG. 1, or a positively charged multi-layer photoconductor for electrophotography shown in FIG. 2.

The conductive substrate 1 serves not only as an electrode of the photoconductor but also as a support of the layers constituting the photoconductor. The conductive substrate 1 may be in any form such as cylinder, plate, or film. The material of the conductive substrate 1 may be a metal such as aluminum, stainless steel, or nickel; or a material such as glass or a resin with a surface that has been subjected to a conductive treatment.

The undercoat layer 2 includes a layer mainly composed of a resin or a metal oxide film such as alumite (anodization). The undercoat layer 2 is formed, as necessary, for the purpose of controlling the injectability of charges from the conductive substrate 1 to the photosensitive layer, or covering defects on the surface of the conductive substrate 1, and improving the adhesion between the photosensitive layer and the conductive substrate 1. Resin materials that can be used for the undercoat layer 2 include insulating polymers such as casein, polyvinyl alcohol, polyamide, melamine, and cellulose; and conductive polymers such as polythiophene, polypyrrole, and polyaniline. These resins may be used alone or in combination as appropriate. The resins to be used may also contain a metallic oxide such as titanium dioxide or zinc oxide.

### (Positively Charged Single-Layer Photoconductor)

In the case of a positively charged single-layer photoconductor, a single-layer photosensitive layer 3 contains specific electron transport materials as described above. In the positively charged single-layer photoconductor, the single-layer photosensitive layer 3 is a single-layer positively charged photosensitive layer mainly containing a charge generation material, a hole transport material, an electron transport material (acceptor compound), and a resin binder in a single layer.

Any known material may be selected and used as appropriate as the charge generation material of the single-layer photosensitive layer 3. Specifically, any charge generation materials that are photosensitive to the wavelength from the exposure light source may be used, including organic pigments such as phthalocyanine pigments, azo pigments, quinacridone pigments, indigo pigments, perylene pigments, perinone pigments, squarylium pigments, thiapyrylium pigments, polycyclic quinone pigments, anthanthrone pigments, and benzimidazole pigment. Specifically, the phthalocyanine pigments include metal-free phthalocyanine, titanyl phthalocyanine, chlorogallium phthalocyanine, hydroxygallium phthalocyanine, and copper phthalocyanine; the azo pigments include disazo pigments, and trisazo pigments; and the perylene pigments include N, N′-bis(3,5-dimethylphenyl)-3,4:9,10-perylene-bis(carboxyimide). In an especially preferred embodiment, metal-free phthalocyanine or titanyl phthalocyanine is used. Examples of metal-free phthalocyanine that can be used include X-metal-free phthalocyanine, and τ-metal-free phthalocyanine. Examples of titanyl phthalocyanine that can be used include α-titanyl phthalocyanine, β-titanyl phthalocyanine, Y-titanyl phthalocyanine, amorphous titanyl phthalocyanine, and titanyl phthalocyanine having a maximum peak at a Bragg angle 2θ of 9.6° in an X-ray diffraction spectrum using CuKα described in JPH08-209023A, U.S. Pat. Nos. 5,736,282A and 5,874,570A. The charge generation materials described above can be used alone or in combination of two or more thereof.

Examples of the hole transport material that can be used in the single-layer photosensitive layer 3 include hydrazone compounds, pyrazoline compounds, pyrazolone compounds, oxadiazole compounds, oxazole compounds, arylamine compounds, benzidine compounds, stilbene compounds, styryl compounds, poly-N-vinylcarbazole, and polysilane. Especially preferred is arylamine compounds. The hole transport materials can be used alone or in combination of two or more thereof. A preferred hole transport material is excellent in the ability to transport holes generated upon light irradiation, and is also suitable for combination with a charge generation material. A suitable hole transport material to be used has a hole mobility of 15×10⁻⁶ [cm²/V·s] or more, especially 20×10⁻⁶ to 80×10⁻⁶ [cm²/V·s] when the electric field strength is 20 V/μm. When the hole mobility is 15×10⁻⁶ [cm²/V·s] or less, ghosting is more likely to occur. The hole mobility can be measured using a coating solution obtained by adding a hole transport material to a resin binder so that the content of the hole transport material is 50% by mass. The ratio of the hole transport material to the resin binder is 50:50. The resin binder may be a bisphenol Z-polycarbonate resin. For example, Iupizeta PCZ-500 (product name, MITSUBISHI GAS CHEMICAL COMPANY, INC.) may be used. Specifically, the coating solution is applied on a substrate and dried at 120° C. for 30 minutes to prepare a coated film having a thickness of 7 μm. Then, the TOF (Time of Flight) method can be used to measure the hole mobility at a constant electric field strength of 20 V/μm. The measurement temperature is 300 K.

Specific examples of the hole transport material include compounds having a structure represented by the following general formula (HT1):

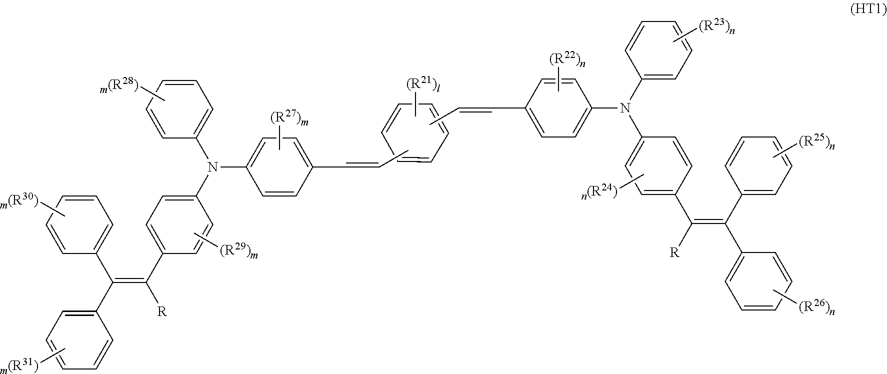

wherein,

R²¹ represents a hydrogen atom or an optionally substituted C₁₋₃ alkyl group,

R²² to R³¹ each independently represent a hydrogen atom, a halogen atom, an optionally substituted C₁₋₆ alkyl group, or an optionally substituted C₁₋₆ alkoxy group

l, m, and n each represent an integer of 0 to 4, and

R represents a hydrogen atom or an optionally substituted C₁₋₃ alkyl group.

Specific examples of the compound having a structure represented by the above general formula (HT1) as a hole transport material include the following.

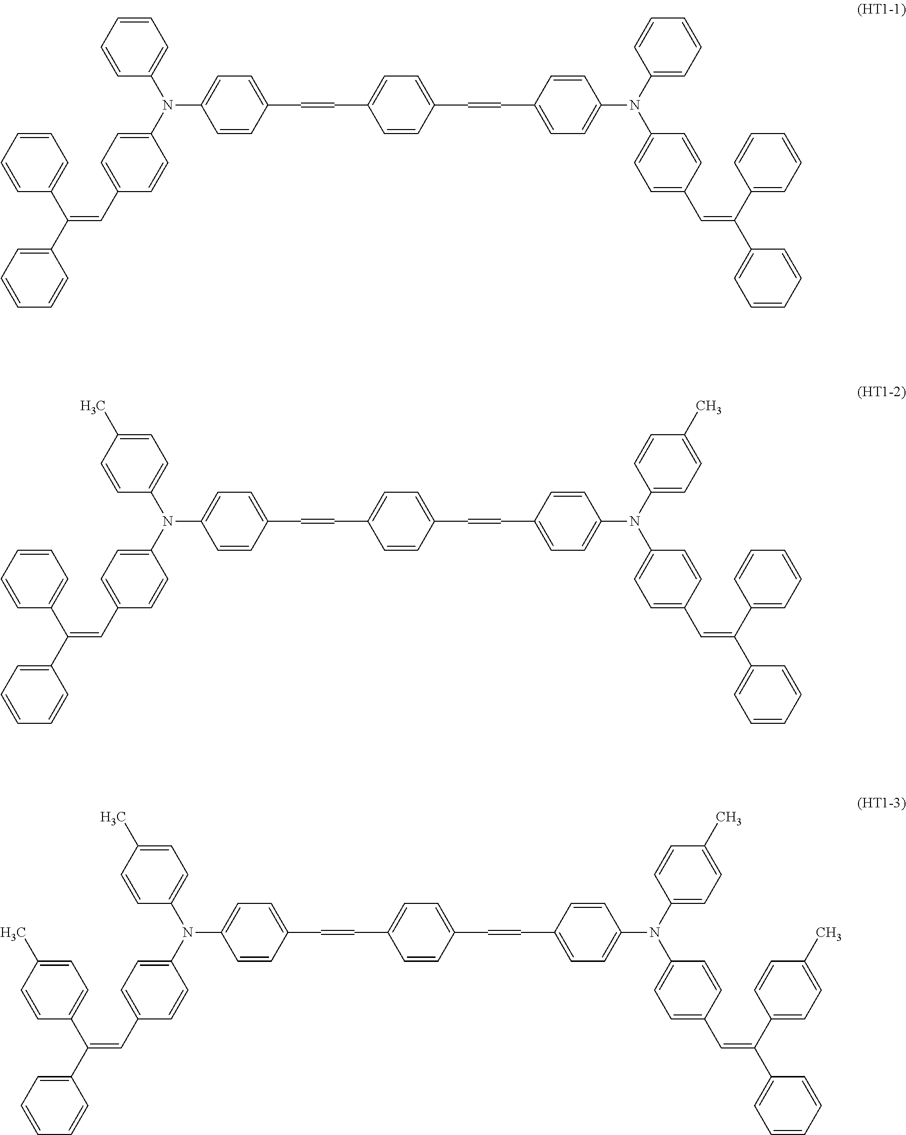

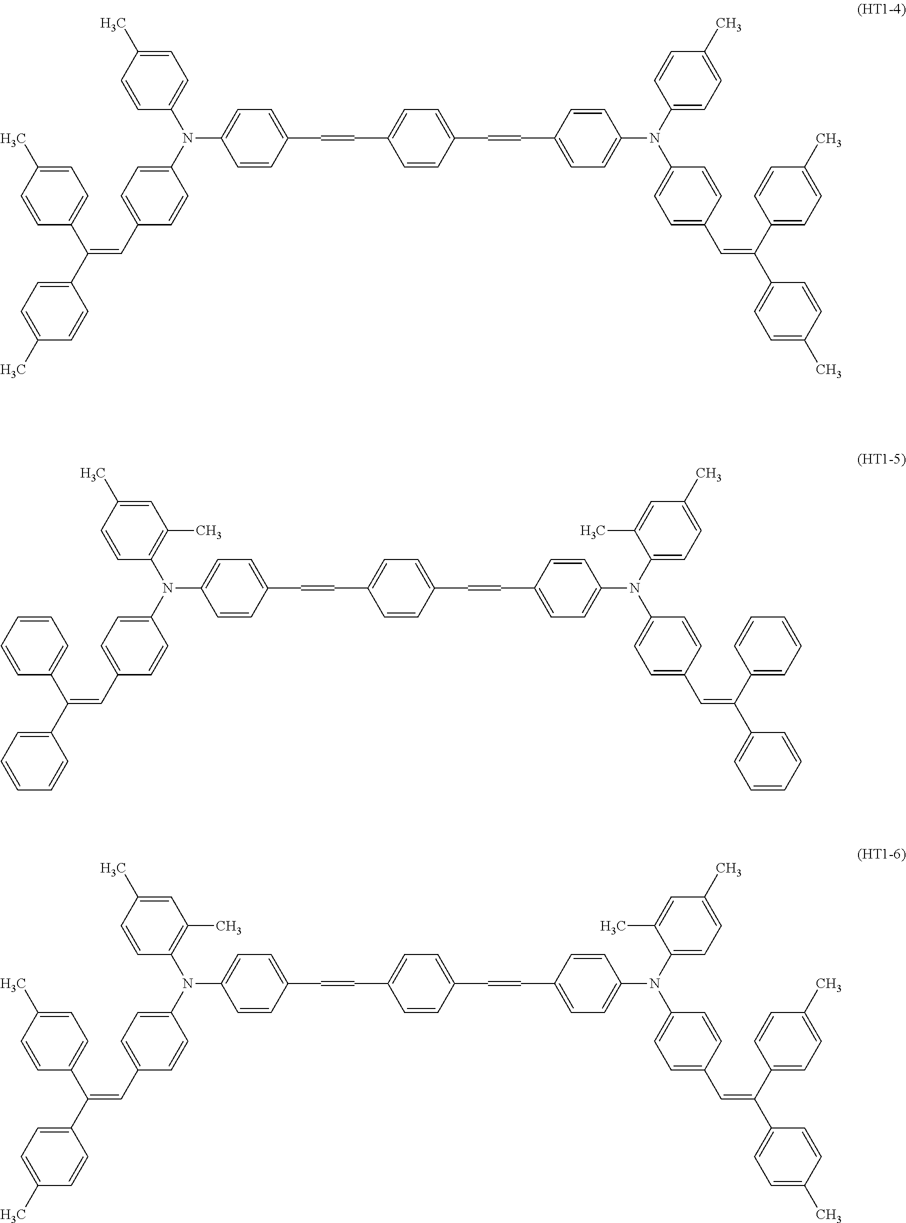

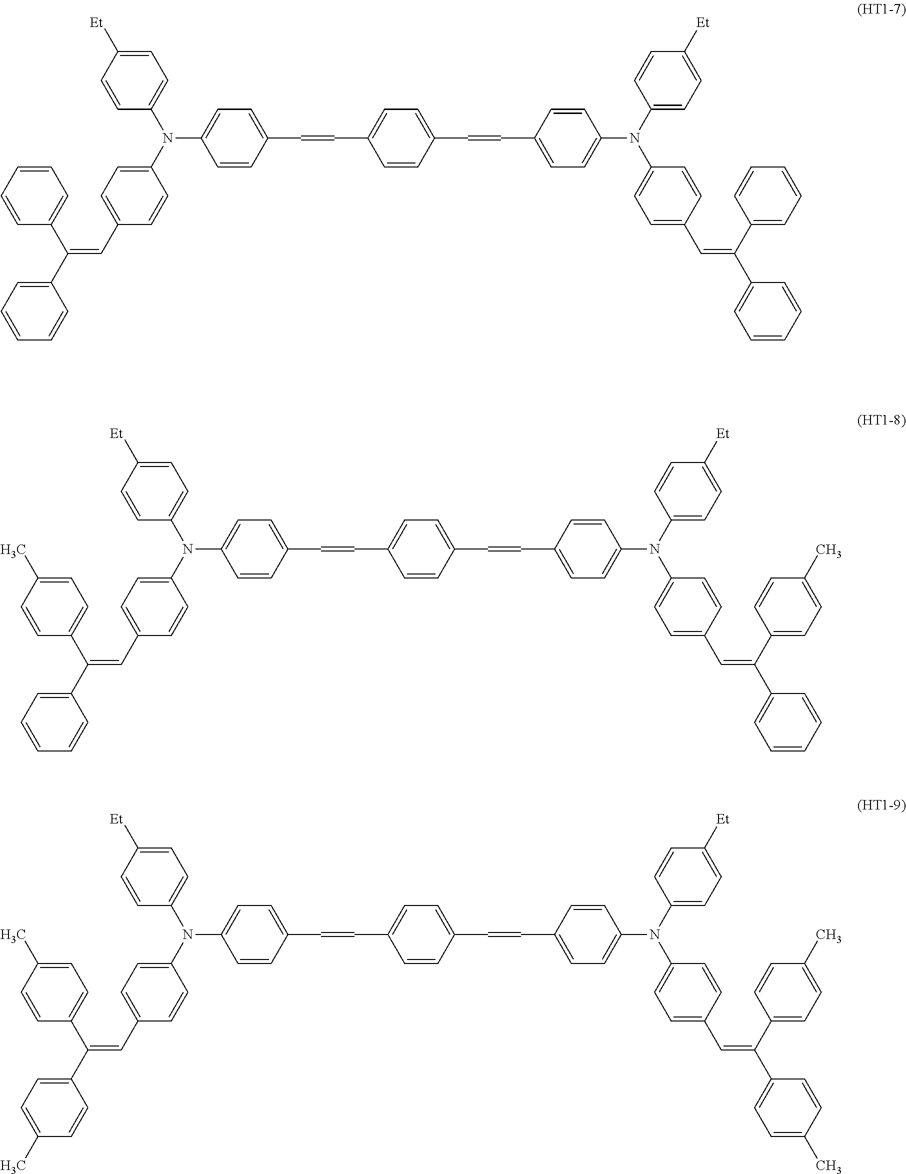

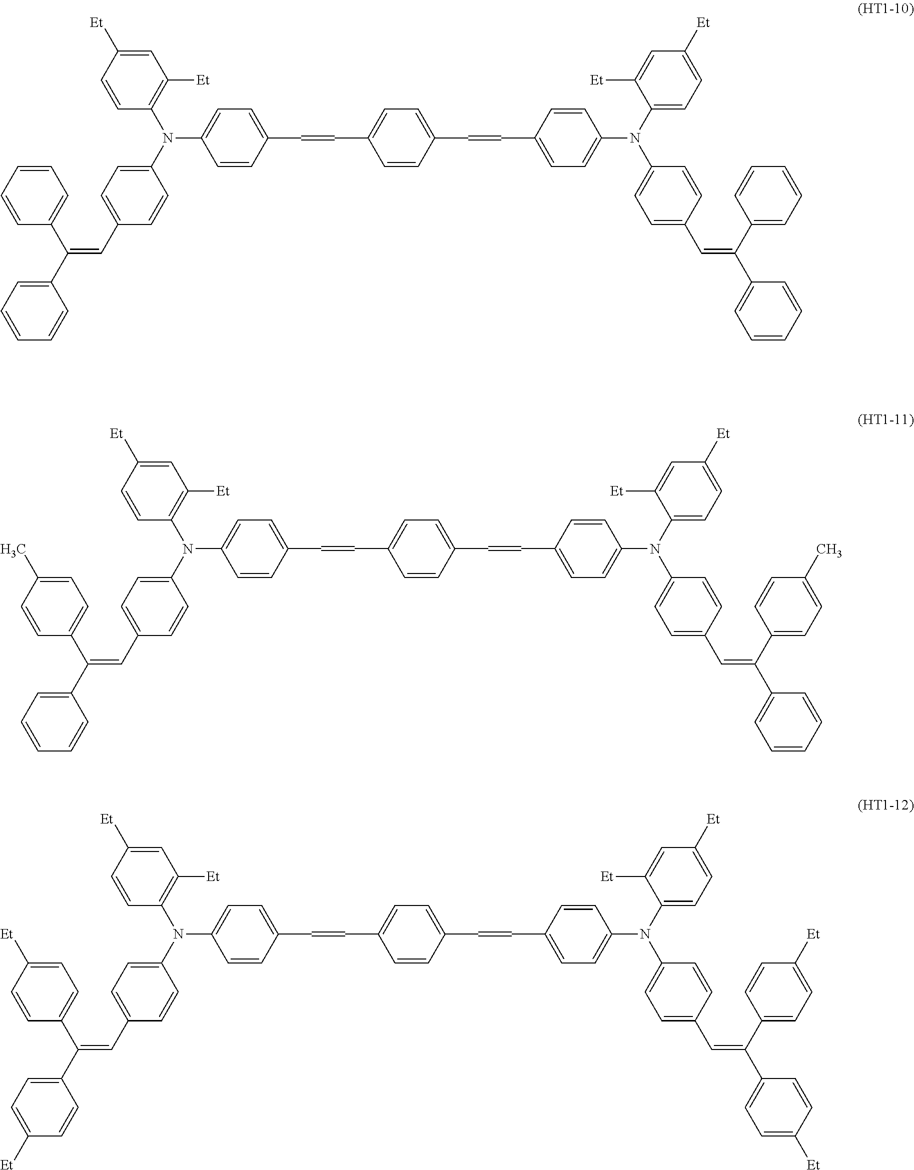

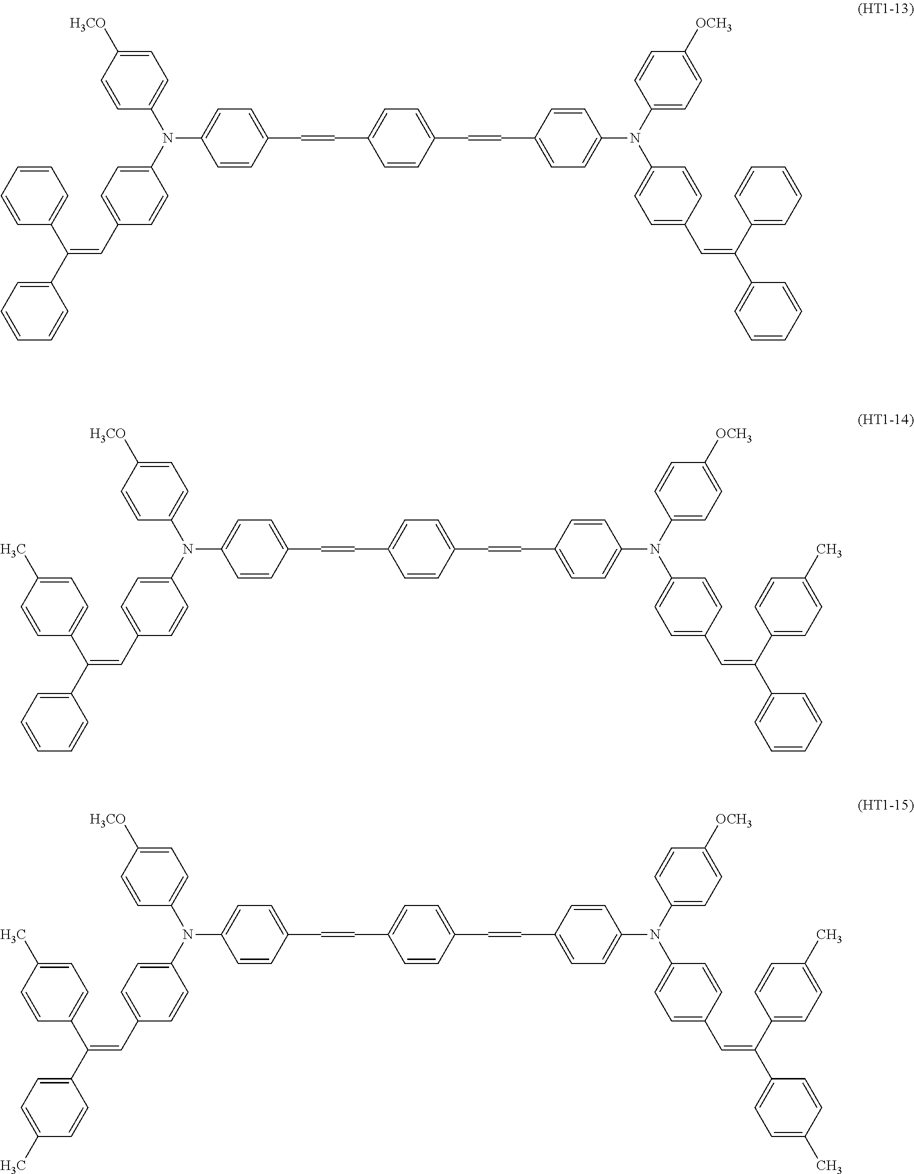

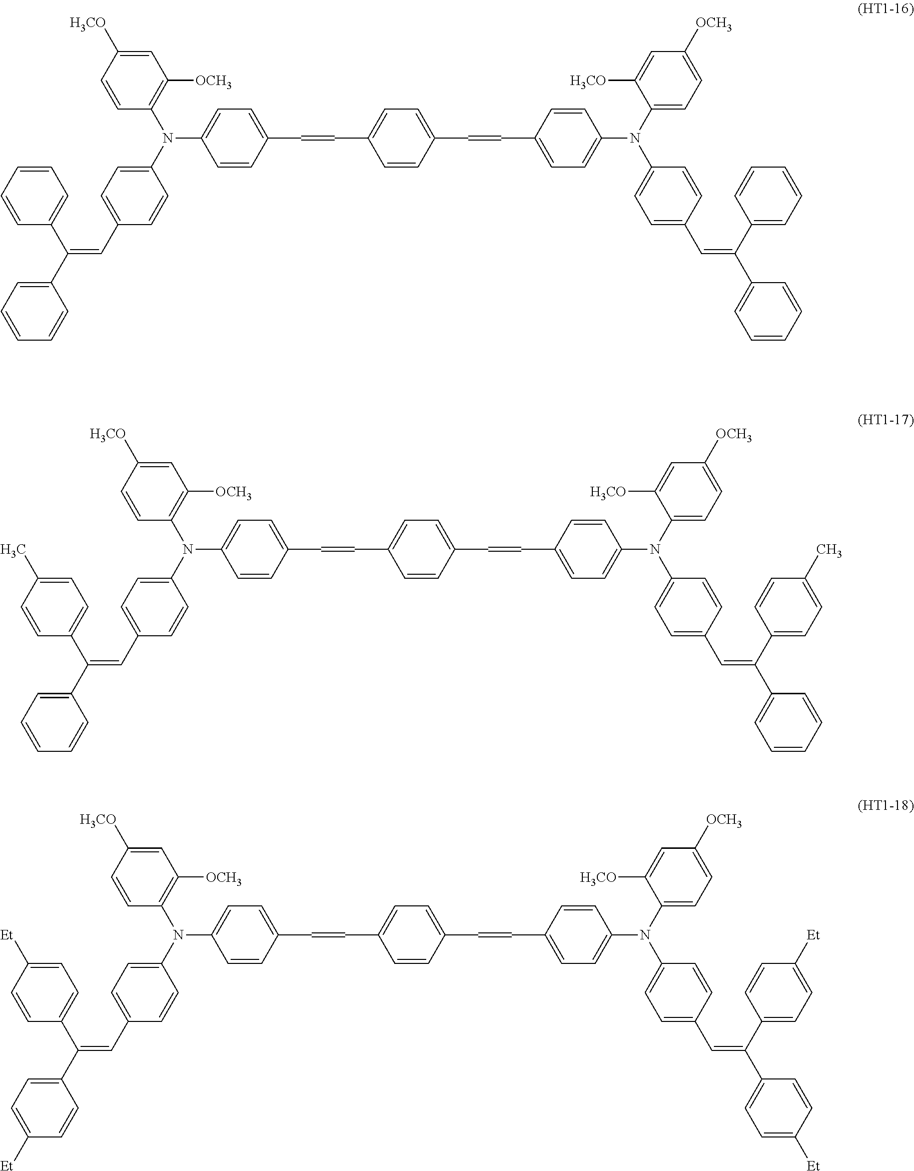

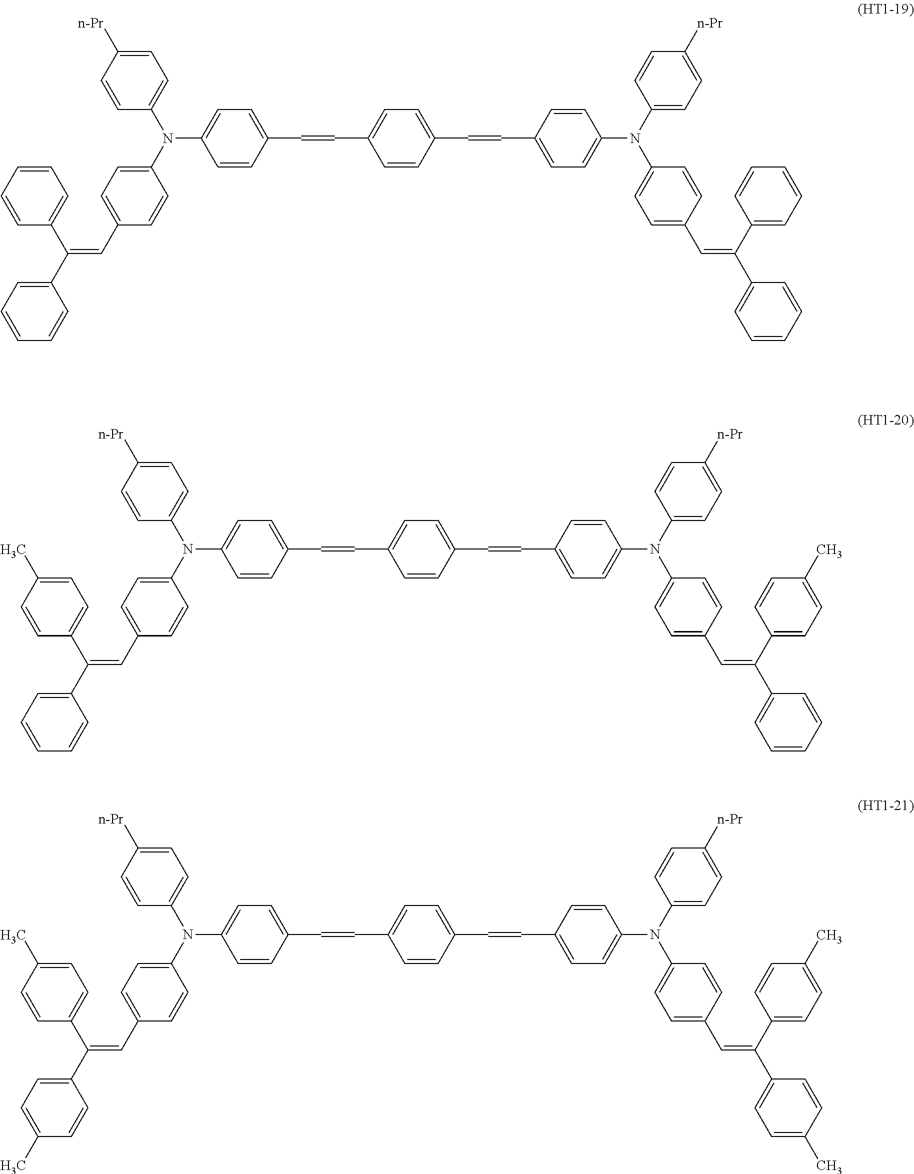

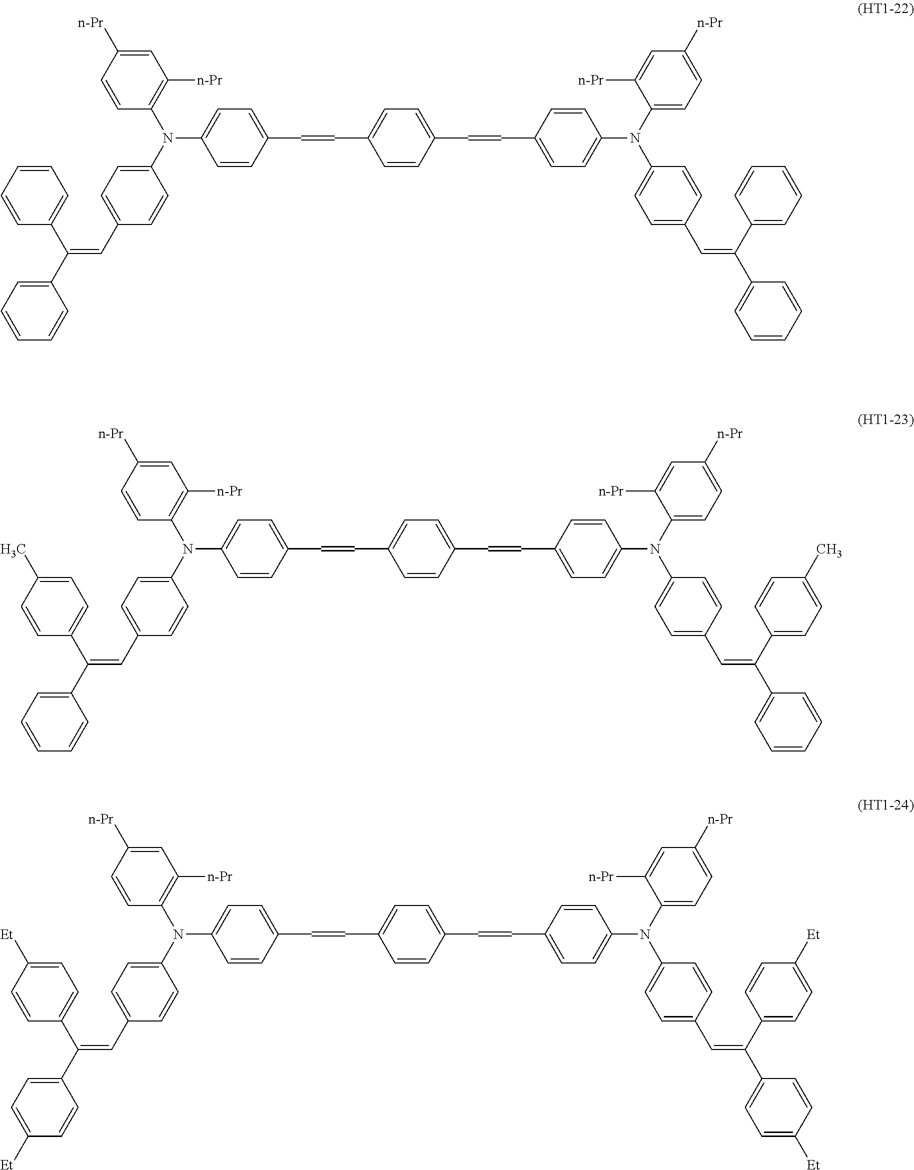

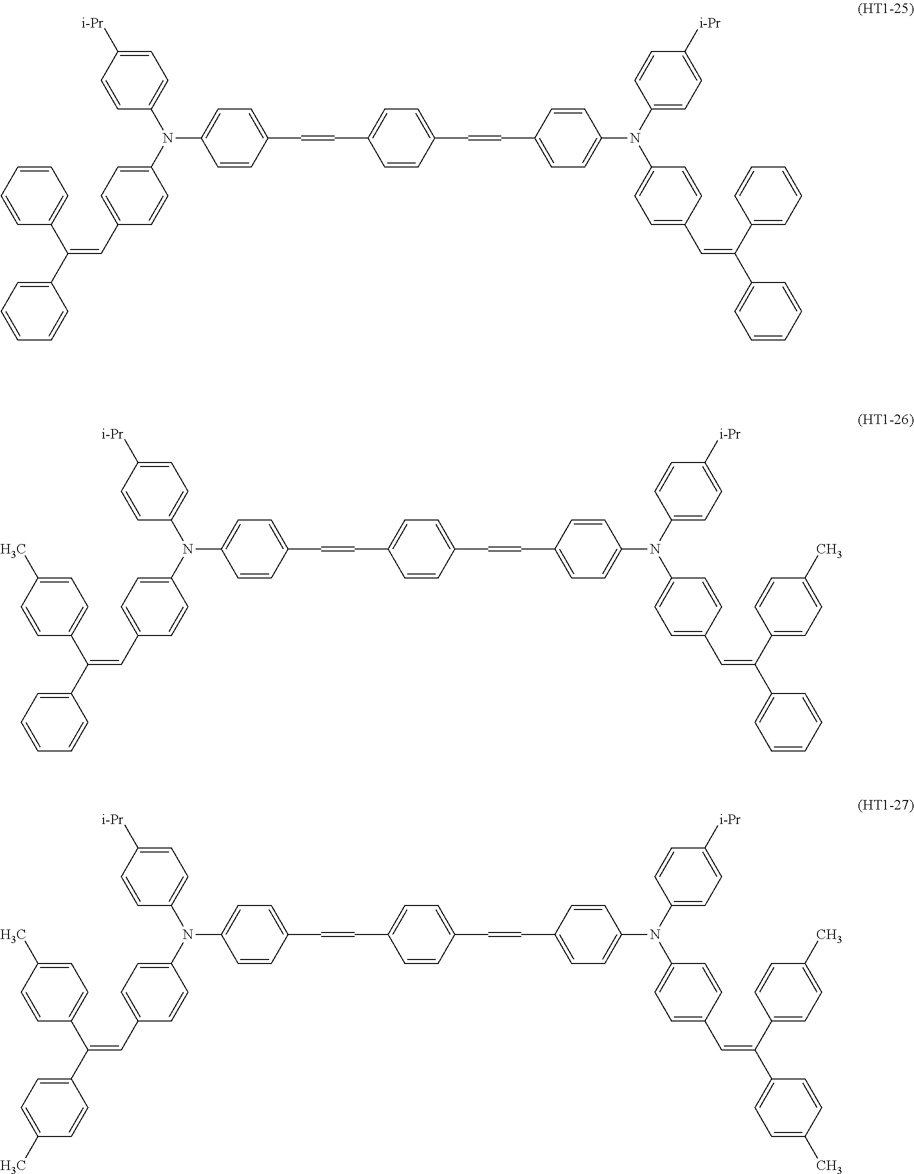

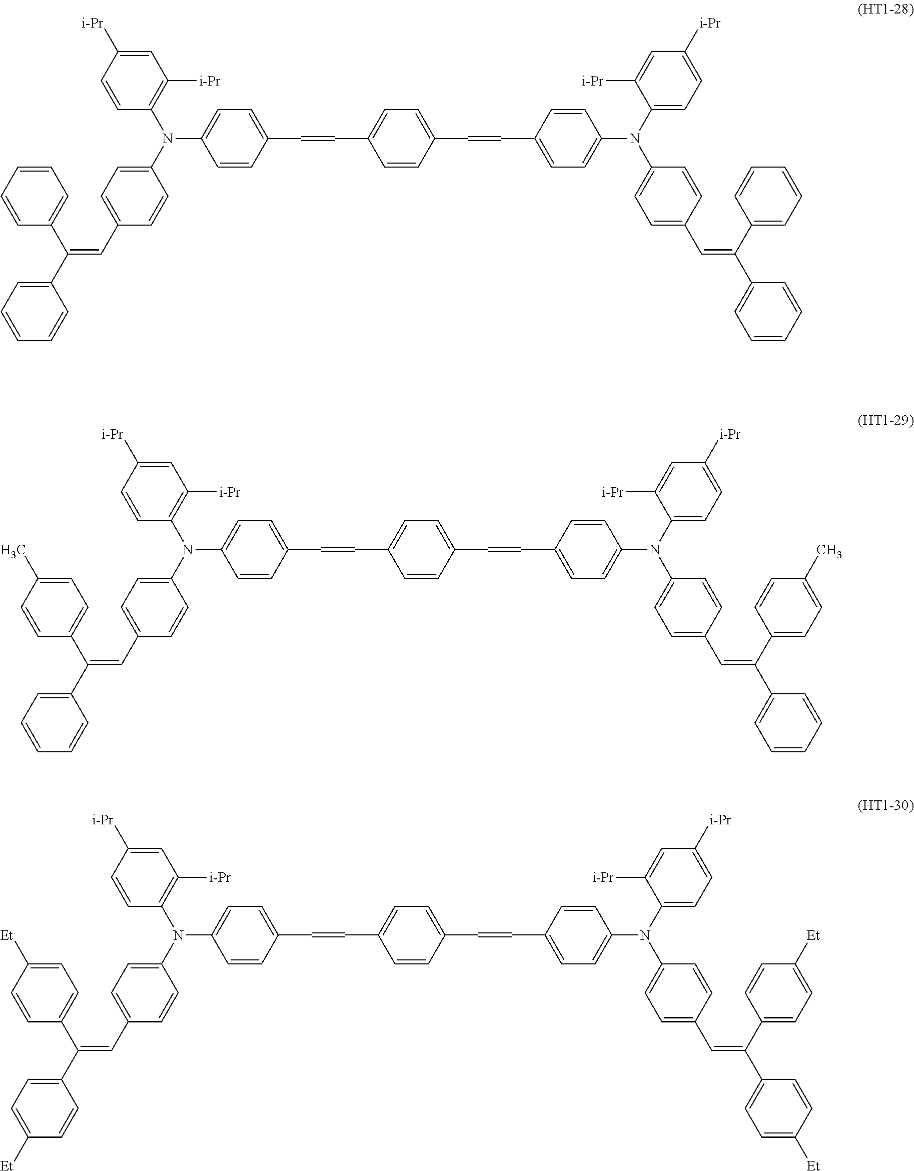

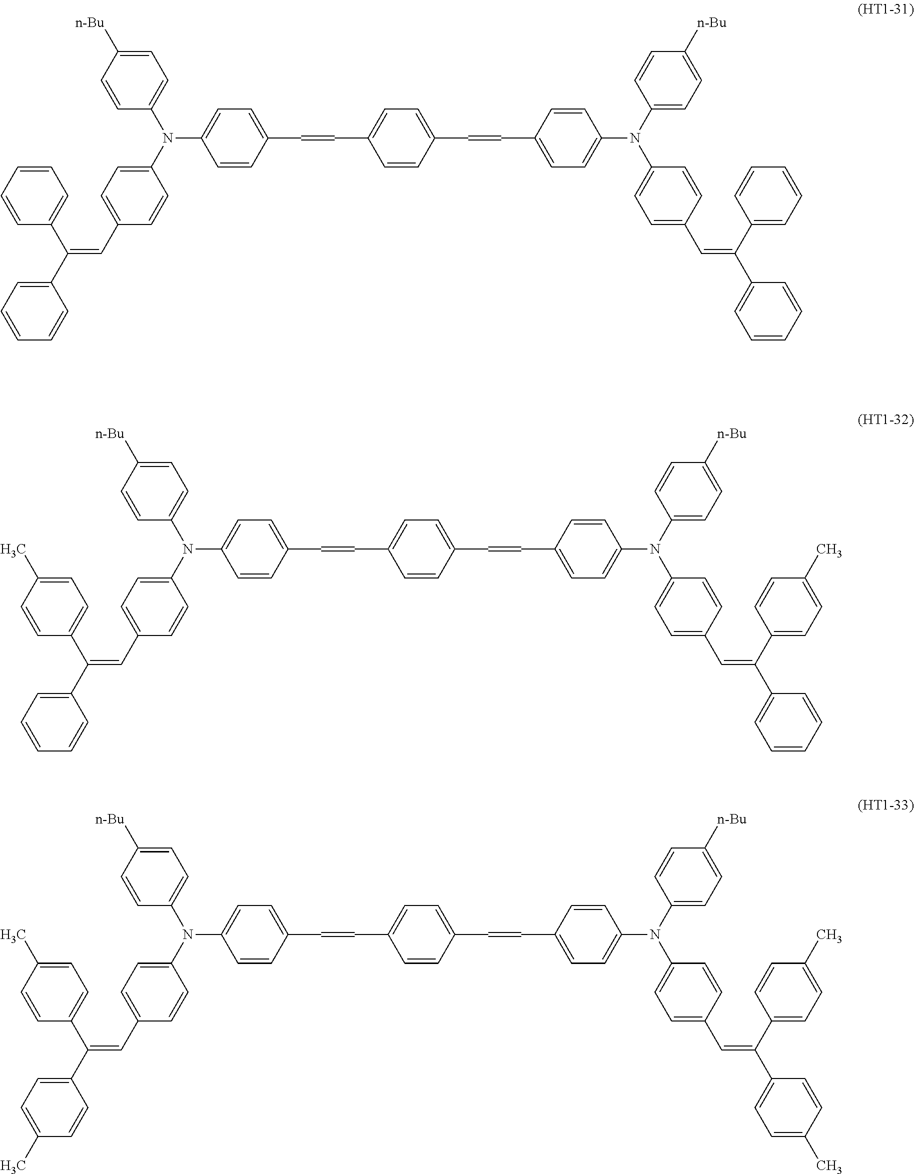

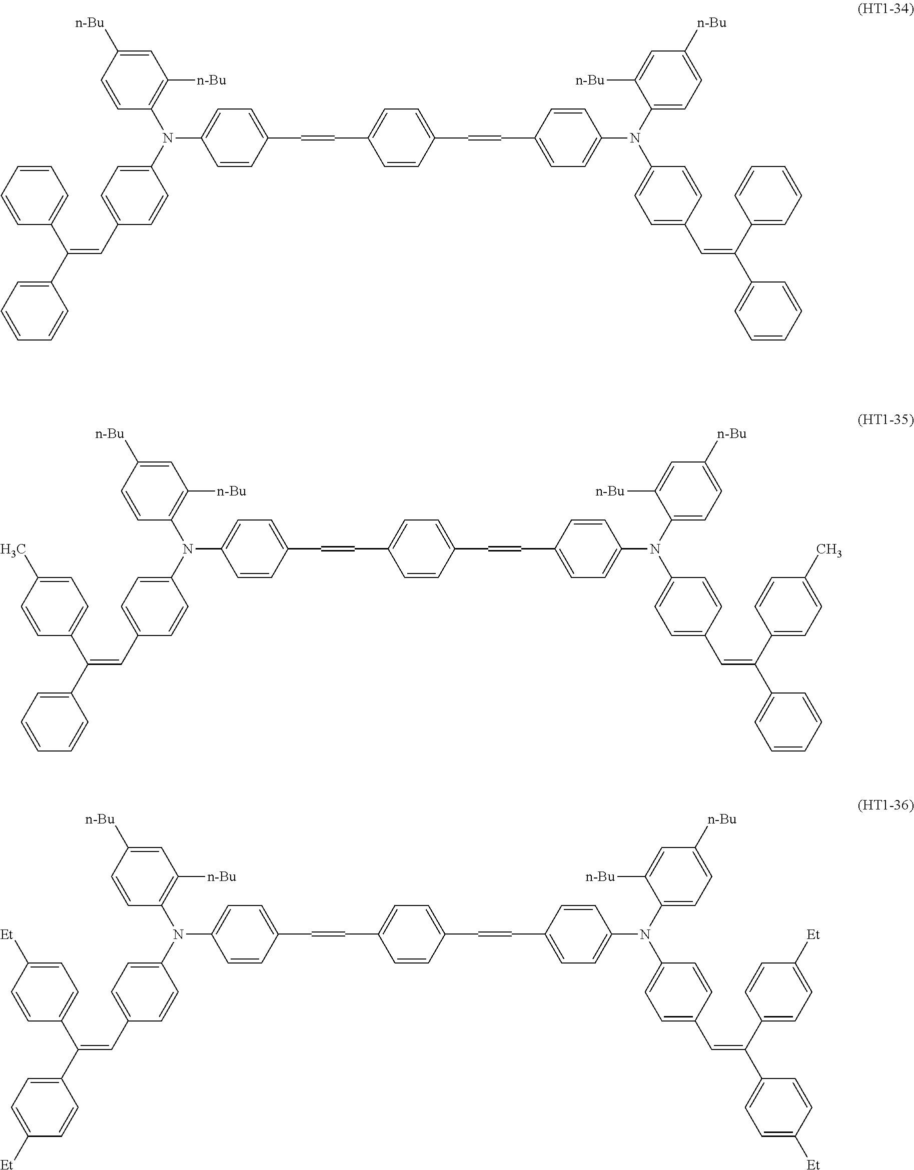

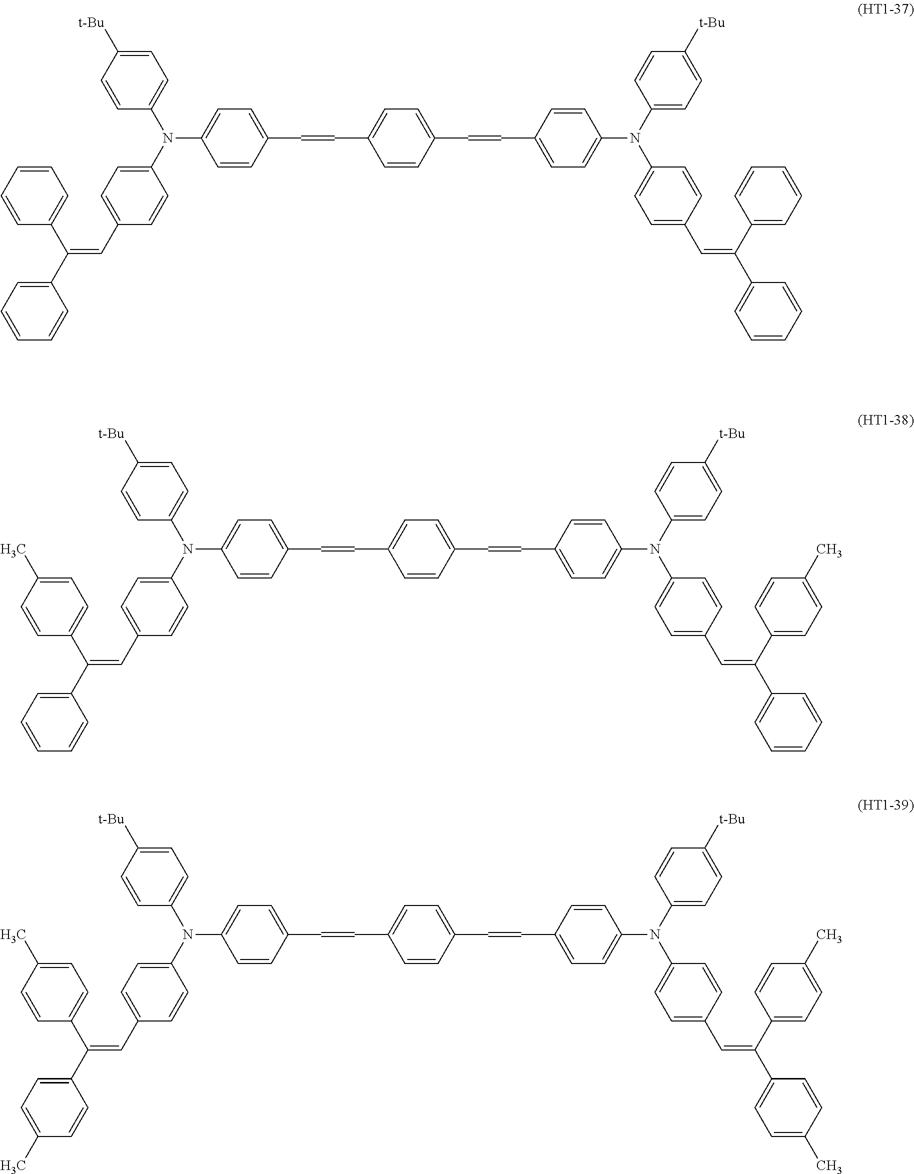

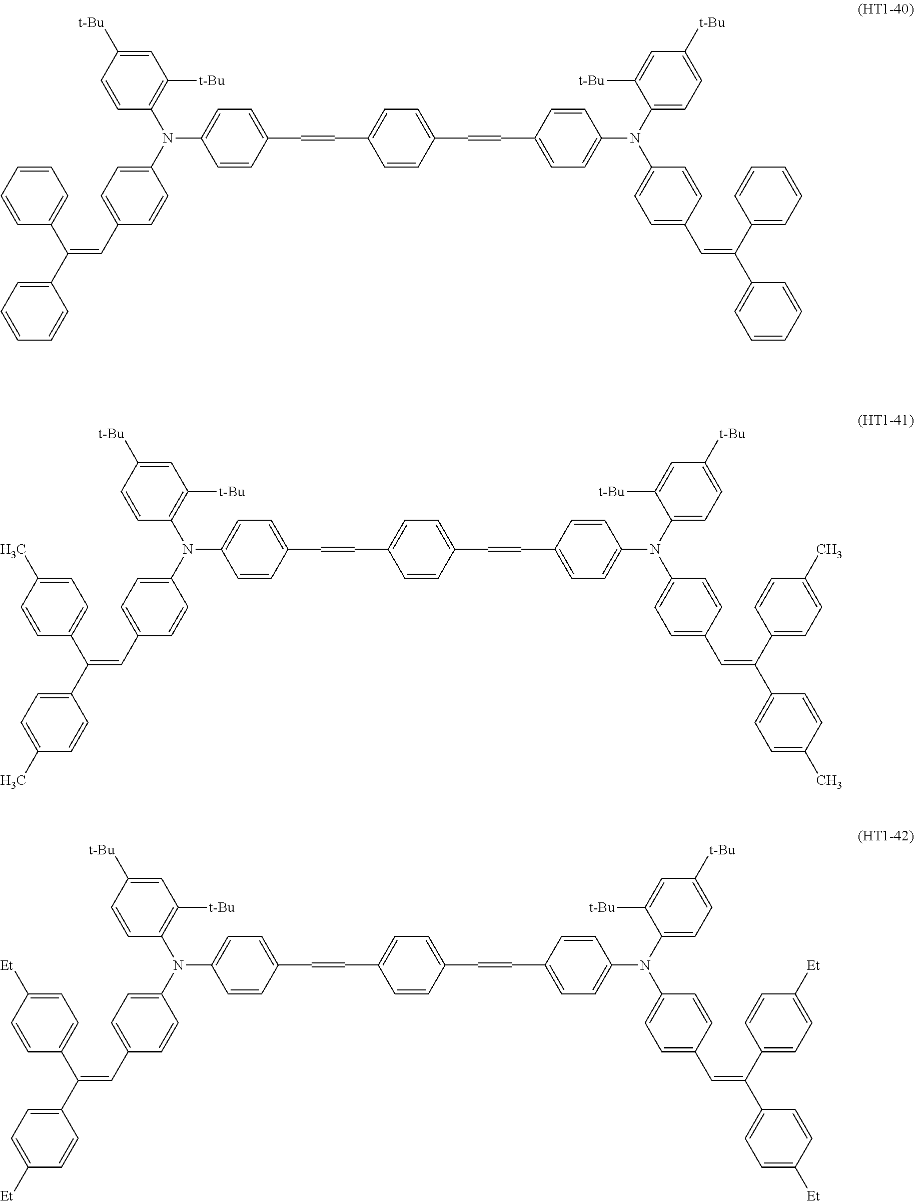

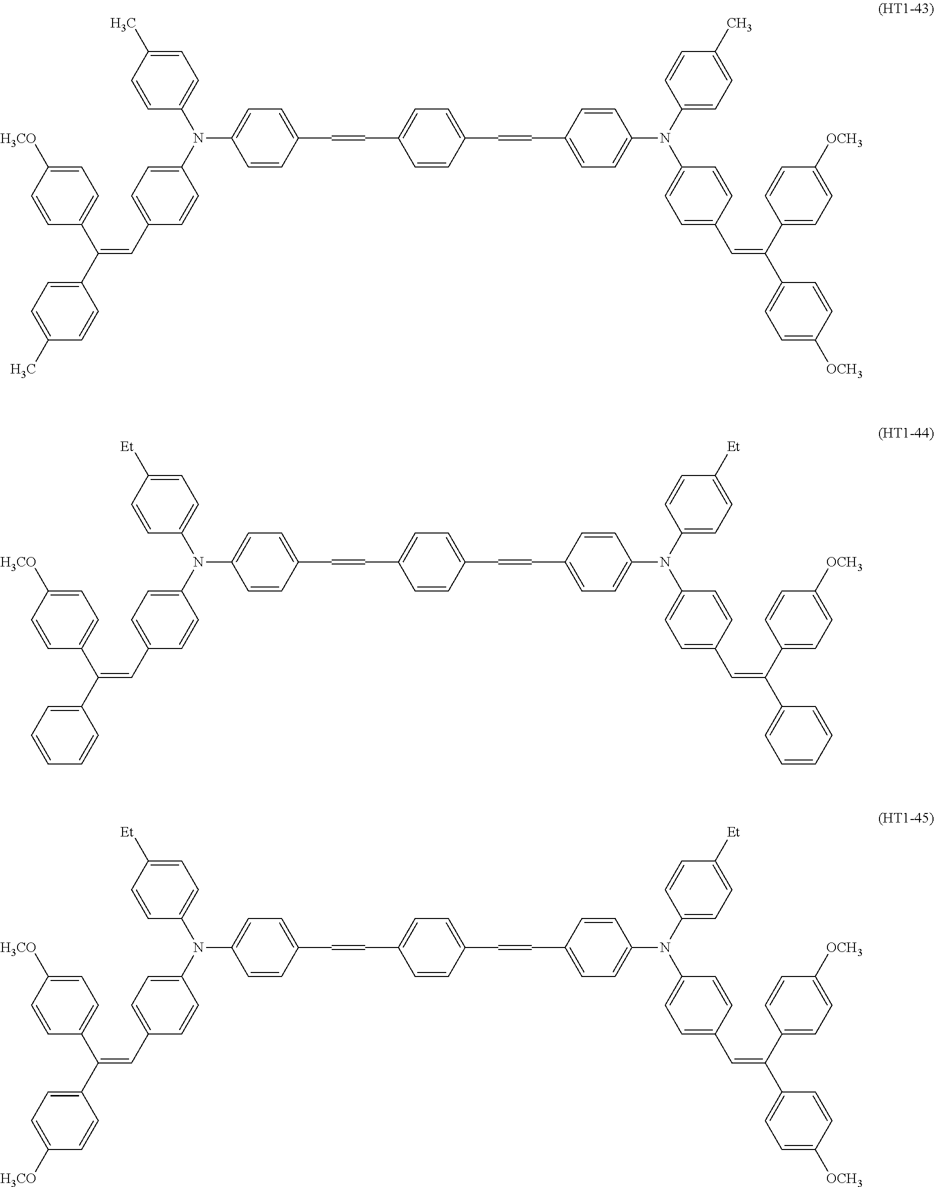

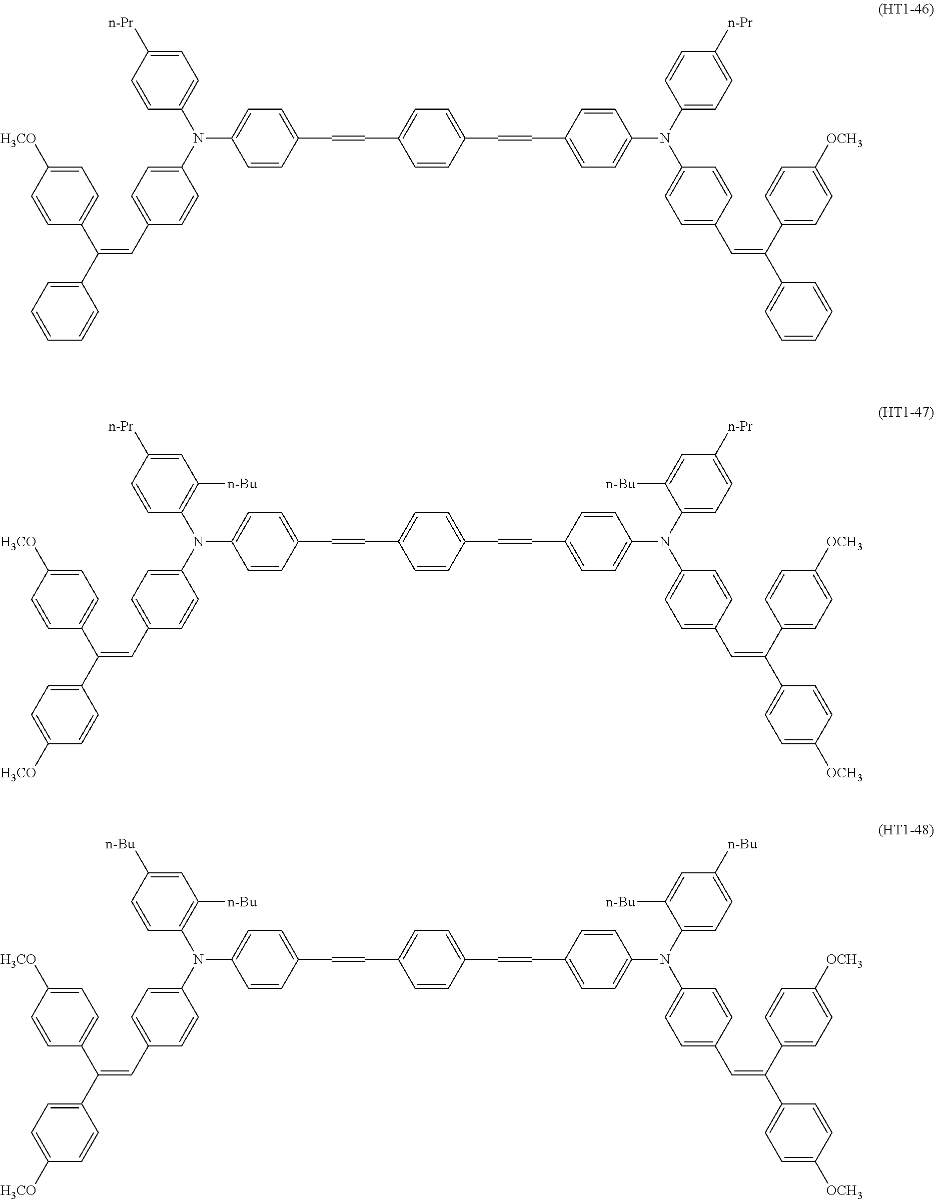

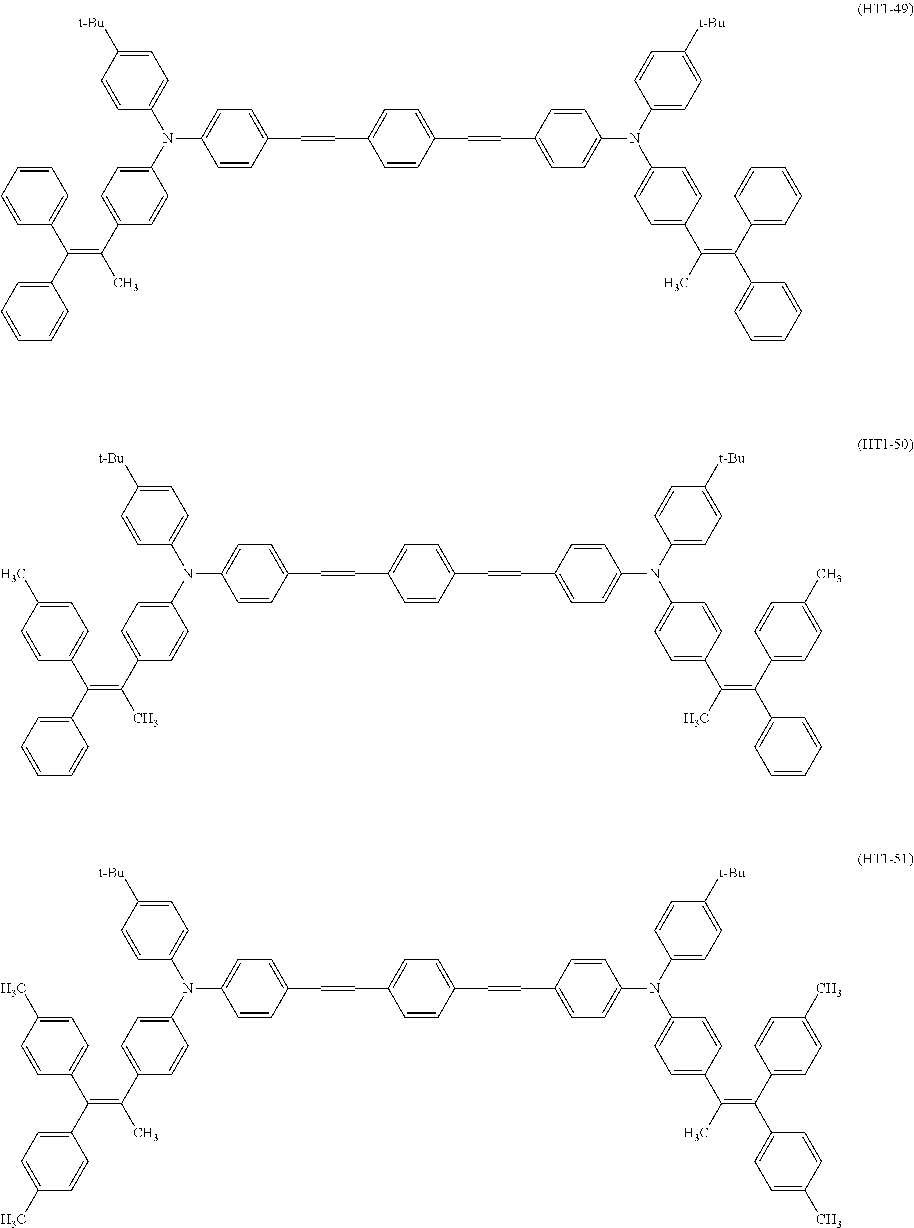

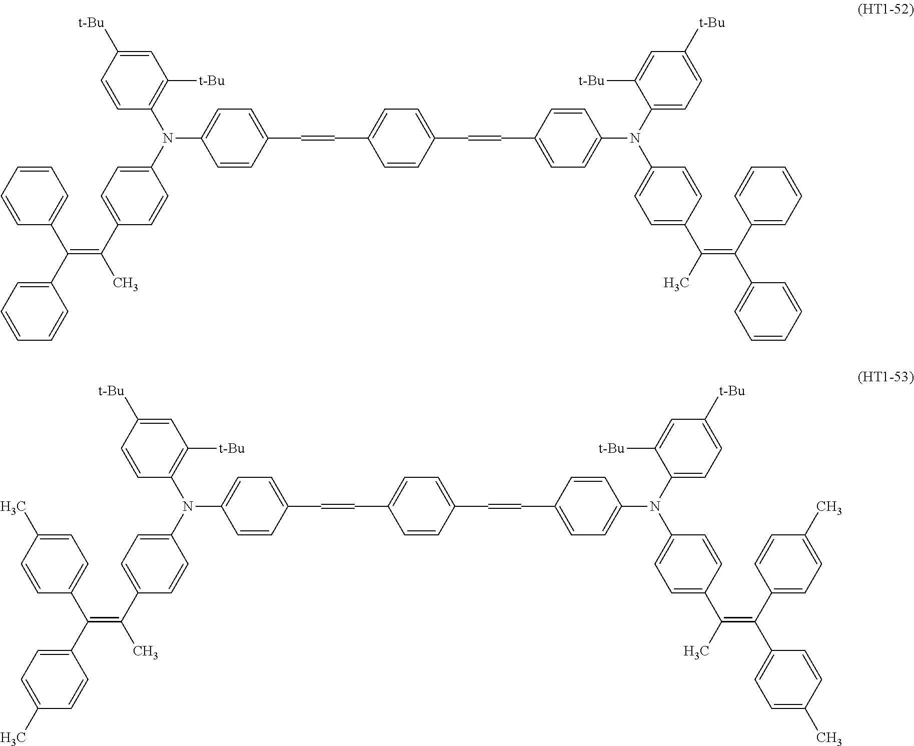

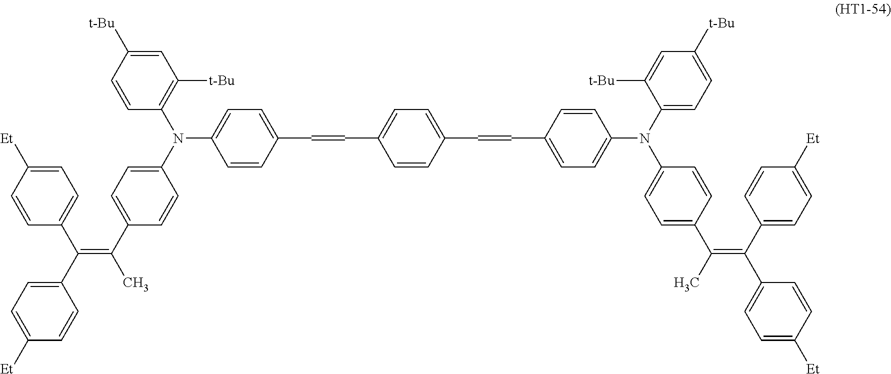

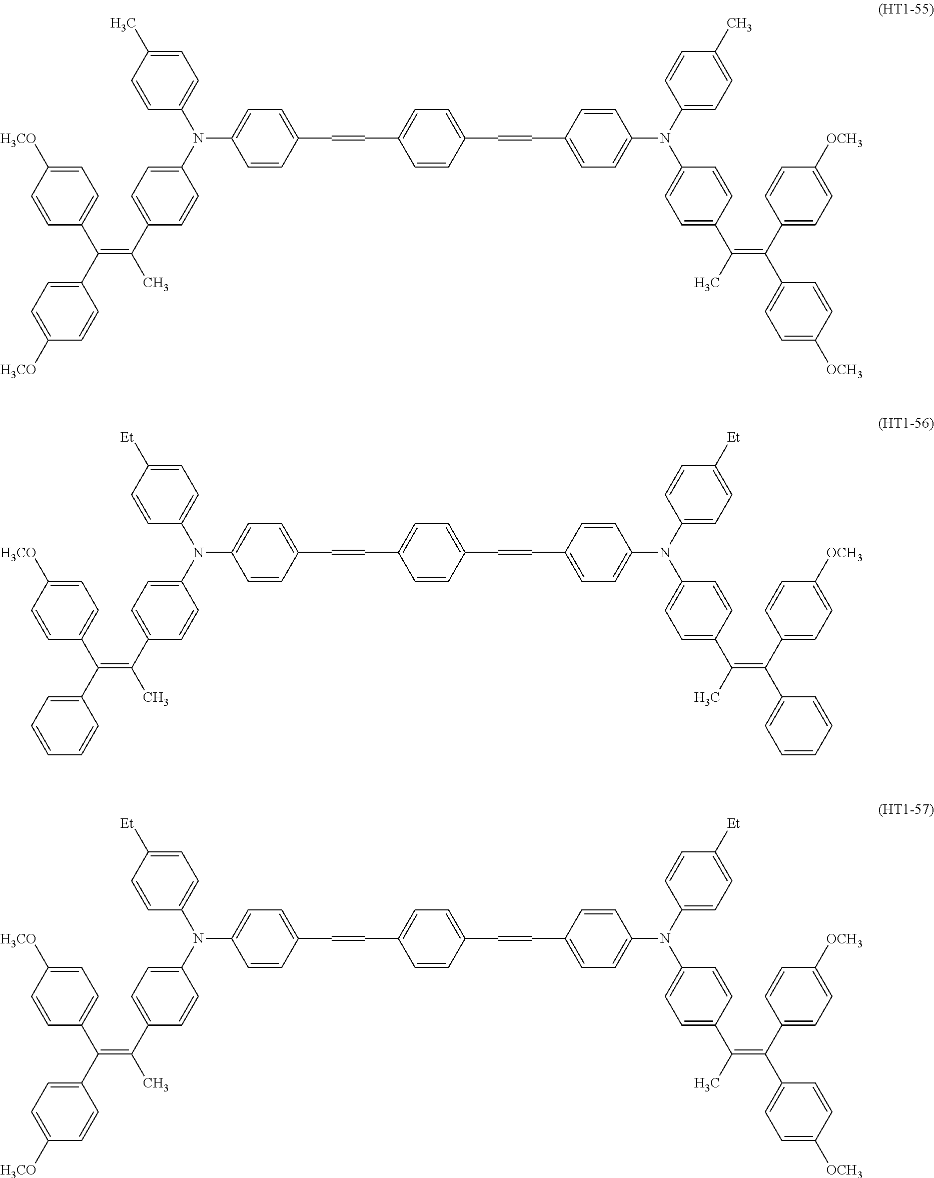

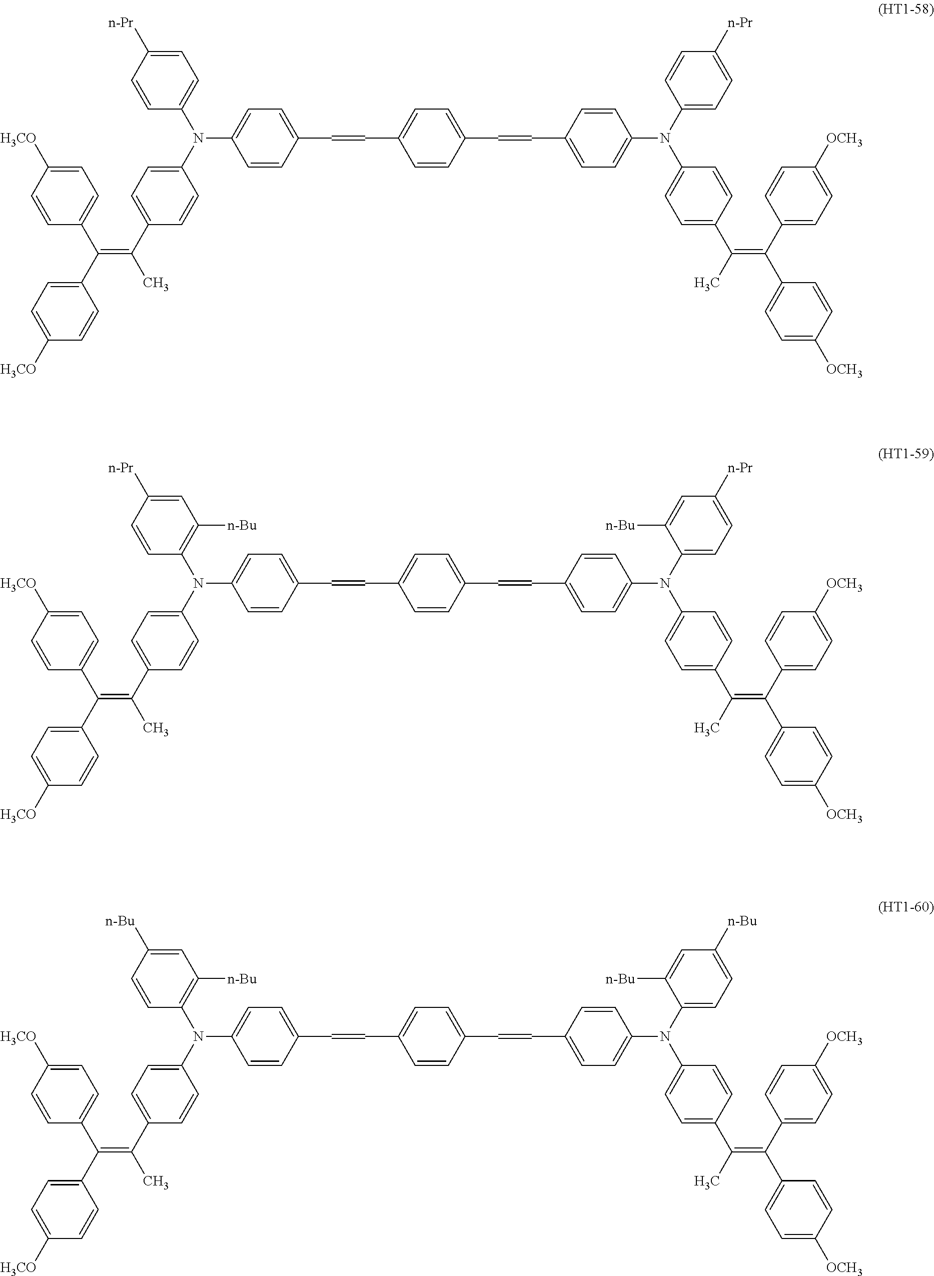

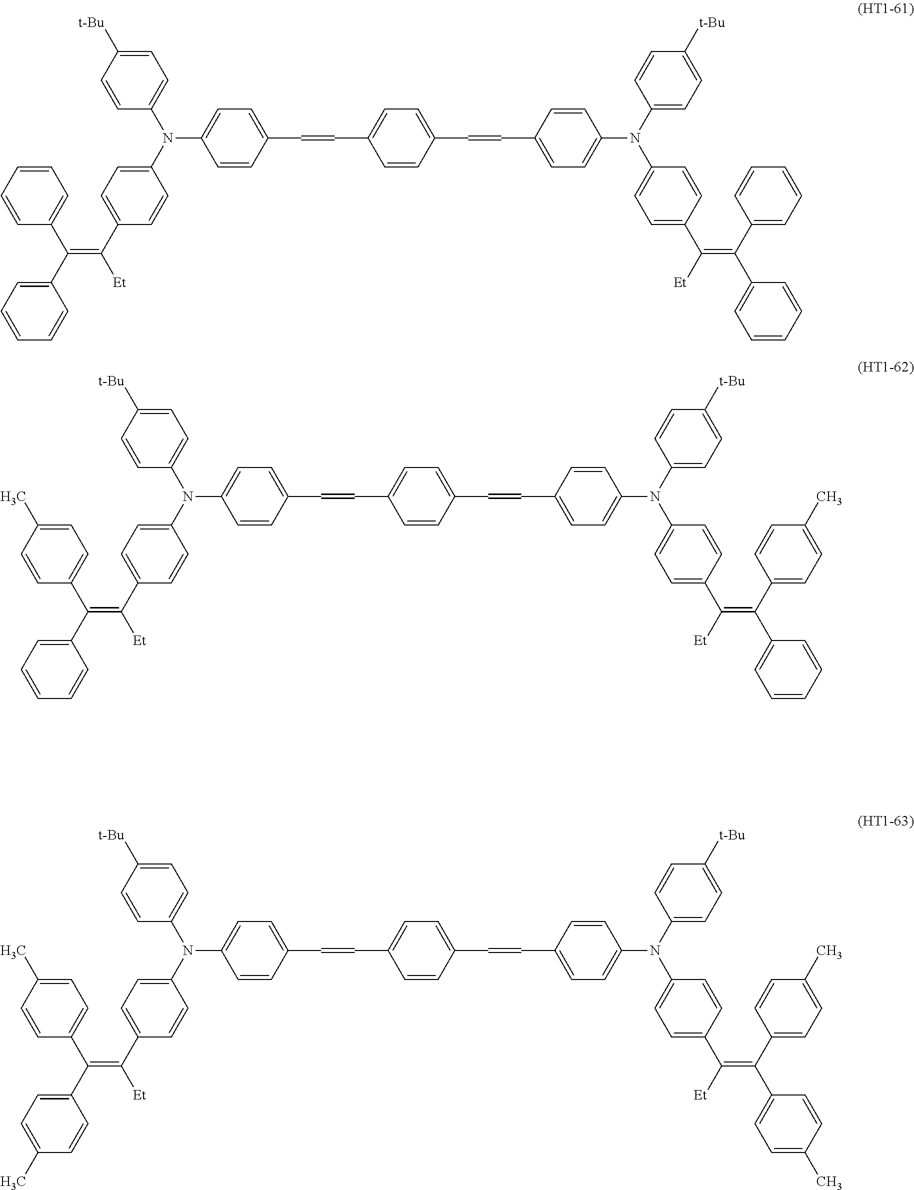

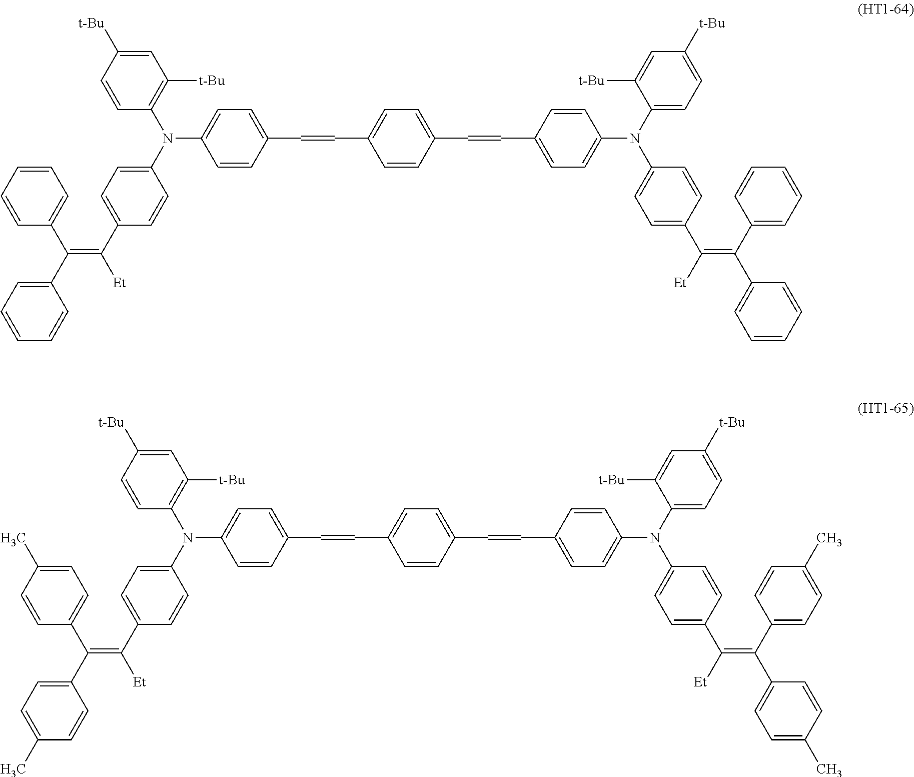

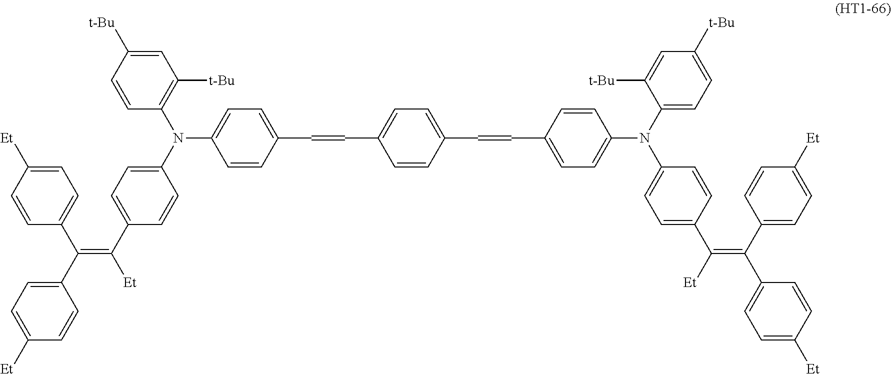

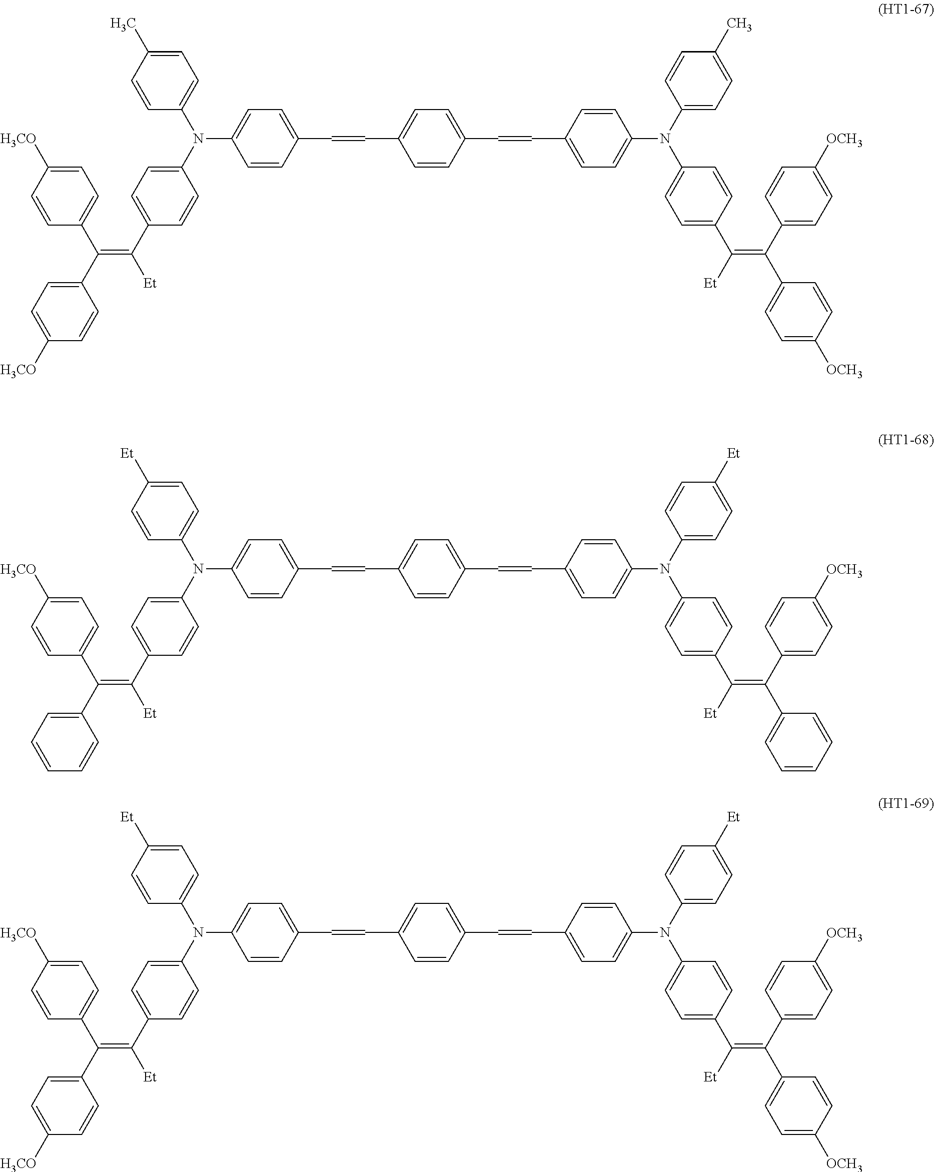

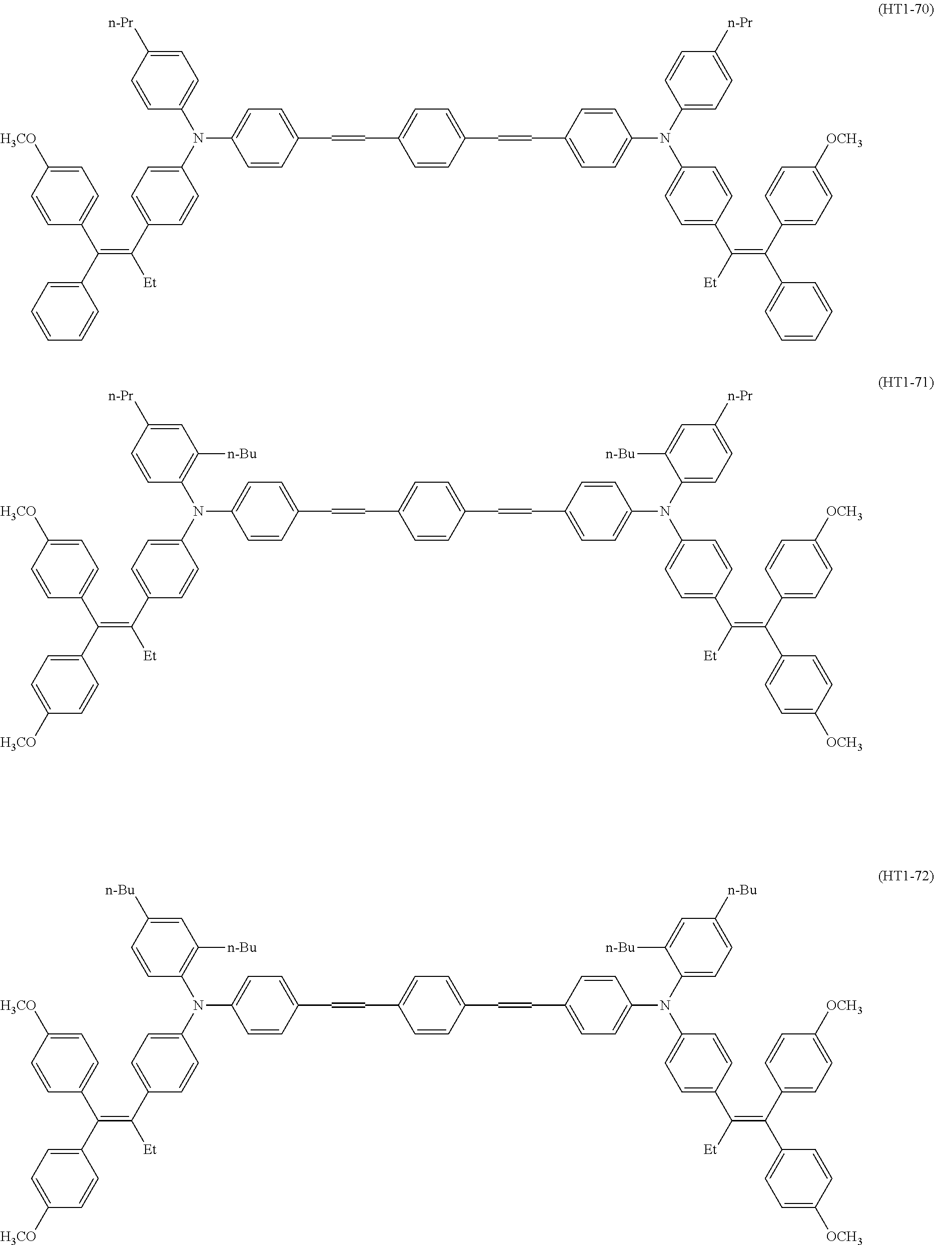

Specific examples of the hole transport material further include the following compounds.

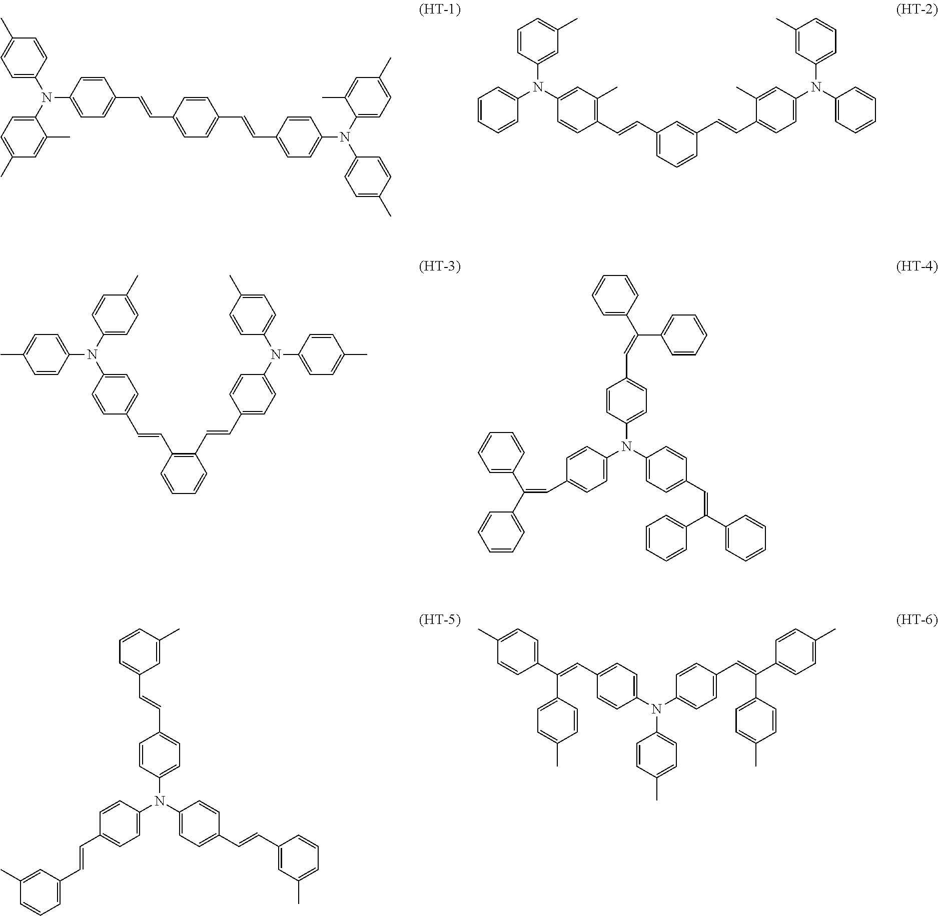

Examples of the resin binder that can be used in the single-layer photosensitive layer 3 include various polycarbonate resins, such as bisphenol A, bisphenol Z, bisphenol A-biphenyl copolymers, bisphenol Z-biphenyl copolymers; polyphenylene resins, polyester resins, polyvinyl acetal resins, polyvinyl butyral resins, polyvinyl alcohol resins, polyvinyl chloride resins, polyvinyl acetate resins, polyethylene resins, polypropylene resins, acrylic resins, polyurethane resins, epoxy resins, melamine resins, silicone resins, polyamide resins, polystyrene resins, polyacetal resins, polyarylate resins, polysulfone resins, methacrylate polymers, and copolymers thereof. The same type of resins having different molecular weights may also be used in combination.

Suitable examples of the resin binder include resins having a repeating unit represented by the following general formula (GB1). More specific examples of the suitable resin binder include polycarbonate resins having a repeating unit represented by the following structural formulae (GB1-1) to (GB1-3):

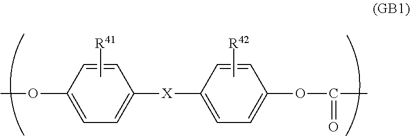

wherein

and R⁴² each represent a hydrogen atom, a methyl group, or an ethyl group,

X represents an oxygen atom, a sulfur atom, or —CR⁴³R⁴⁴,

R⁴³ and R⁴⁴ each represent a hydrogen atom, a C₁₋₄ alkyl group, or an optionally substituted phenyl group,

alternatively, R⁴³ and R⁴⁴ may be linked together into a ring, forming an optionally substituted C₄₋₆ cycloalkyl group, and

R⁴³ and R⁴⁴ may be the same or different.

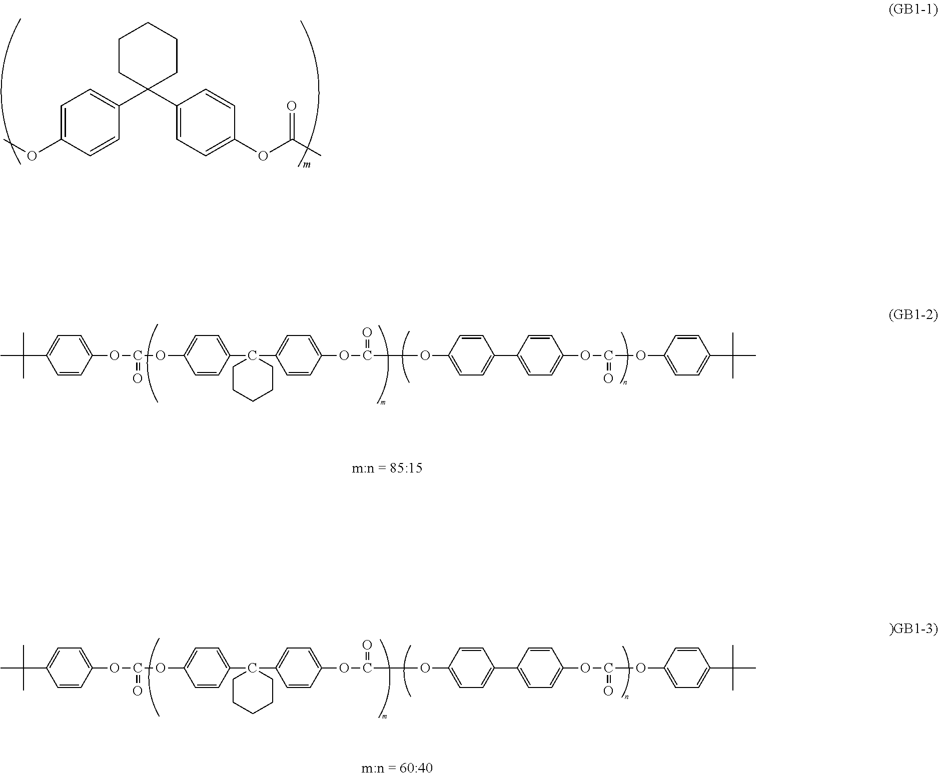

The content of the charge generation material in the single-layer photosensitive layer 3 is preferably from 0.1 to 5% by mass, more preferably from 0.5 to 3% by mass, relative to the solid content of the single-layer photosensitive layer 3. The content of the hole transport material in the single-layer photosensitive layer 3 is preferably from 3 to 60% by mass, more preferably from 10 to 40% by mass, relative to the solid content of the single-layer photosensitive layer 3. The content of the electron transport material in the single-layer photosensitive layer 3 is preferably from 1 to 50% by mass, more preferably from 5 to 20% by mass, relative to the solid content of the single-layer photosensitive layer 3. The ratio of the contents of the hole transport material and the electron transport material may range from 4:1 to 3:2. The content of the resin binder in the single-layer photosensitive layer 3 is preferably from 20 to 80% by mass, more preferably from 30 to 70% by mass, relative to the solid content of the single-layer photosensitive layer 3.

The thickness of the single-layer photosensitive layer 3 is preferably within the range from 3 to 100 μm, more preferably within the range from 5 to 40 μm, in order to maintain a practically effective surface potential.

### (Positively Charged Multi-Layer Photoconductor)

In the case of a positively charged multi-layer photoconductor, a multi-layer positively charged photosensitive layer 6 including a charge transport layer 4 and a charge generation layer 5 contains specific electron transport materials as described above. The charge transport layer 4 and the charge generation layer 5 are stacked in sequence on a conductive substrate 1. In the positively charged multi-layer photoconductor, the charge transport layer 4 contains at least a first hole transport material and a resin binder, while the charge generation layer 5 contains at least a charge generation material, a second hole transport material, a specific electron transport material as described above, and a resin binder. In the positively charged multi-layer photoconductor, the charge transport layer 4 may further contain an electron transport material.

As the first hole transport material and the resin binder in the charge transport layer 4, the same materials as those listed for the single-layer photosensitive layer 3 can be used.

The content of the first hole transport material in the charge transport layer 4 is preferably from 10 to 80% by mass, more preferably from 20 to 70% by mass, relative to the solid content of the charge transport layer 4. The content of the charge transport layer 4 in the charge transport layer 4 is preferably from 20 to 90% by mass, more preferably from 30 to 80% by mass, relative to the solid content of the charge transport layer 4.

The thickness of the charge transport layer 4 is preferably within the range from 3 to 50 μm, more preferably within the range from 15 to 40 μm, in order to maintain a practically effective surface potential.

As the charge generation material, the second hole transport material, the electron transport material, and the resin binder in the charge generation layer 5, the same materials as those listed for the single-layer photosensitive layer 3 can be used.

The content of the charge generation material in the charge generation layer 5 is preferably from 0.1 to 5% by mass, more preferably from 0.5 to 3% by mass, relative to the solid content of the charge generation layer 5. The content of the second hole transport material in the charge generation layer 5 is preferably from 1 to 30% by mass, more preferably from 5 to 20% by mass, relative to the solid content of the charge generation layer 5. The content of the electron transport material in the charge generation layer 5 is preferably from 5 to 65% by mass, more preferably from 10 to 60% by mass, relative to the solid content of the charge generation layer 5. In the case where two or more electron transport materials are used in combination, the content of the electron transport materials may be from 50 to 60% by mass relative to the solid content of the charge generation layer 5. The ratio of the contents of the second hole transport material and the electron transport material may range from 1:3 to 1:10. The content of the resin binder in the charge generation layer 5 is preferably from 20 to 80% by mass, more preferably from 30 to 70% by mass, relative to the solid content of the charge generation layer 5.

The thickness of the charge generation layer 5 can be the same as that of the single-layer photosensitive layer 3 of the single-layer photoconductor.

In embodiments of the present invention, the photosensitive layer of the photoconductor, whether of the multi-layer type or the single-layer type, can contain a leveling agent, such as a silicone oil or a fluorine-based oil, for the purpose of improving the leveling properties of or imparting lubricity to the film to be formed. Two or more inorganic oxides can also be contained for the purpose of adjusting film hardness, reducing the coefficient of friction, and imparting lubricity. The photosensitive layer may contain microparticles composed of metallic oxide, such as silica, titanium oxide, zinc oxide, calcium oxide, alumina, or zirconium oxide; of metal sulfate, such as barium sulfate, or calcium sulfate; or of metal nitride, such as silicon nitride, or aluminum nitride; or fluorine-based resin particles, such as a tetrafluoroethylene resin; or fluorine-based comb-like graft polymerized resin particles. The photosensitive layer can further contain, as needed, other well-known additives without significantly impairing the electrophotographic characteristics.

The photosensitive layer can also contain an antidegradant such as an antioxidant or a light stabilizer for the purpose of improving the environmental resistance and the stability against harmful light. Examples of the compound used for such a purpose include chromanol derivatives such as tocopherol, and esterified compounds, polyarylalkane compounds, hydroquinone derivatives, etherified compounds, dietherified compounds, benzophenone derivatives, benzotriazole derivatives, thioether compounds, phenylenediamine derivatives, phosphonates, phosphites, phenol compounds, hindered phenol compounds, linear amine compounds, cyclic amine compounds, and hindered amine compounds.

### (Method of Manufacturing Photoconductor)

The method of manufacturing the photoconductor according to embodiments of the present invention includes the steps, for manufacturing the photoconductor for electrophotography, of preparing a photosensitive layer coating solution containing an azoquinone derivative having a structure represented by the general formula (ET1) as described above, and forming a photosensitive layer by dip coating using the prepared photosensitive layer coating solution.

Specifically, the single-layer photoconductor can be manufactured by a method including the steps of: dissolving and dispersing an electron transport material containing the specific azoquinone derivative as described above, and any charge generation material, hole transport material, and resin binder in a solvent to prepare a coating solution for forming a single-layer photosensitive layer; and applying the obtained coating solution for forming a single-layer photosensitive layer onto the outer circumference of a conductive substrate, via an undercoat layer as desired, and drying it to form a photosensitive layer.

In the case of the multi-layer photoconductor, a charge transport layer is formed by a method including the steps of: first dissolving any hole transport material and resin binder in a solvent to prepare a coating solution for forming the charge transport layer; and applying the coating liquid for forming the charge transport layer onto the outer circumference of a conductive substrate, via an undercoat layer as desired, and drying it to form a charge transport layer. Then, a charge generation layer is formed by a method including the steps of: dissolving and dispersing an electron transport material containing the specific azoquinone derivative as described above, and any charge generation material, hole transport material, and resin binder in a solvent to prepare a coating solution for forming a charge generation layer; and applying the coating solution for forming a charge generation layer onto the charge transport layer, and drying it to from a charge generation layer. Such manufacturing methods allow for manufacturing the multi-layer photoconductor in the embodiments of the present invention. The type of the solvent used for the preparation of the coating solution, the coating conditions, the drying conditions, and other conditions can be selected as appropriate according to a conventional method, and are not particularly restricted.

In embodiments of the present invention, the photoconductor for electrophotography can be applied to various machine processes to provide desired effects. Specifically, sufficient effects can be obtained in charging processes such as contact charging systems using a charging member such as a roller or a brush, and non-contact charging systems using a corotron or a scorotron, as well as in developing processes such as contact developing and non-contact developing systems using developers such as nonmagnetic one-component, magnetic one-component, or two-component developers.

### (Electrophotographic Equipment)

In embodiments of the present invention, the electrophotographic equipment includes the photoconductor for electrophotography as described above. In embodiments of the present invention, the electrophotographic equipment has sufficiently high sensitivity and excellent potential stability during repeated printing in various environments, and does not cause problems such as deterioration of gradation or generation of memory images, especially when applied to monochrome high-speed printers and small medium-speed tandem color printers.

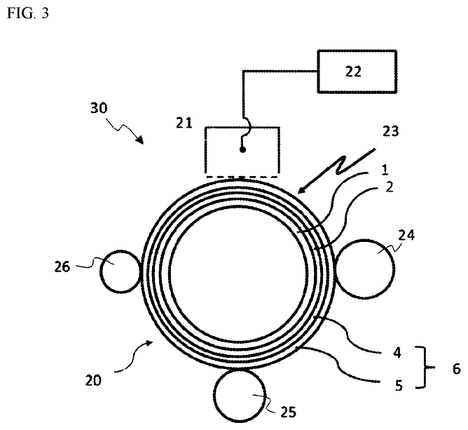

FIG. 3 schematically shows an electrophotographic equipment in one exemplary embodiment of the present invention. As shown, the electrophotographic equipment 30 is equipped with a photoconductor 20 according to an embodiment of the present invention including a conductive substrate 1, and an undercoat layer 2 and a photosensitive layer 6, consisting of a charge transport layer 4 and a charge generation layer 5, coated on the outer circumference of the conductive substrate 1. The electrophotographic equipment 30 includes a charger 21 which is scorotron type in the embodiment shown in the figure arranged on the outer circumference of the photoconductor 20; a high-voltage power supply 22 for supplying an applied voltage to the charger 21; an exposure 23; a developer 24; and a transfer 25. The electrophotographic equipment 30 may further include a cleaner 26. In embodiments of the present invention, the electrophotographic equipment 30 can be a color printer.

### EXAMPLES

Specific embodiments of the present invention will be described in further detail with reference to the examples below. However, the present invention is not limited to the following examples without departing from the spirit and scope of the present invention.

### <Multi-Layer Photoconductor>

### Example 1

A 0.75 mm wall thickness tube made of aluminum, machined to φ30 mm×252.6 mm length and surface roughness (Rmax) of 0.2 μm, was used as a conductive substrate. The conductive substrate had an anodized layer on the surface.

### [Charge Transport Layer]

A compound represented by the above structural formula (HT1-5) as a hole transport material and a polycarbonate resin having the repeating unit represented by the above structural formula (GB1-1) as a resin binder were dissolved in tetrahydrofuran according to the compounding amounts shown in Table 1 below to prepare a coating solution. The coating solution was applied to the conductive substrate by dip coating and dried at 100° C. for 30 minutes to form a charge transport layer with a thickness of 10 μm.

### [Charge Generation Layer]

A compound represented by the above structural formula (HT1-5) as a hole transport material, a compound represented by the above structural formula (ET1-4) as an electron transport material, and a polycarbonate resin having the repeating unit represented by the above structural formula (GB1-2) as a resin binder were dissolved in tetrahydrofuran according to the compounding amounts shown in Table 1 below. After addition of titanyl phthalocyanine represented by the following structural formula (CG1) as a charge generation material to the solution, the mixture was subjected to dispersion treatment with a disperser (DYNO-MILL Research Lab type manufactured by Willy A. Bachofen AG) under the conditions of beads: φ 0.4 ZrO, filling ratio: 70%, rotation speed: 3000 rpm, and 3 passes to prepare a coating solution. The coating solution was applied to the charge transport layer by dip coating and dried at 110° C. for 30 minutes to form a charge generation layer with a thickness of 15 μm, thereby obtaining a multi-layer photoconductor for electrophotography having a thickness of 25 μm and including photosensitive layers.

The solubility S_{ETM} (THF) of the azoquinone derivative, as represented by the mass (g) of tetrahydrofuran required to dissolve 1 g of the azoquinone derivative having a structure represented by the above structural formula (ET1-4)), was 1 (g).

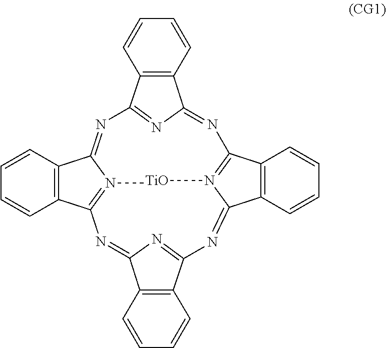

### Examples 2 to 30 and Comparative Examples 1 to 11

Positively charged multi-layer photoconductors for electrophotography were obtained in the same manner as in Example 1 except that the types and amounts of the materials and the thicknesses of the layers were changed according to the conditions shown in Tables 1 to 3 below. The structural formulae of the materials used in Comparative Examples are shown below.

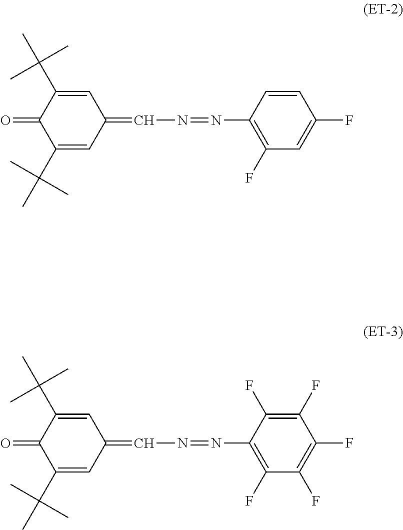 [SMILES: CC(C)(C)C1=CC(=CN=Nc2ccc(F)cc2F)C=C(C(C)(C)C)C1=O ; CC(C)(C)C1=CC(=CN=Nc2c(F)c(F)c(F)c(F)c2F)C=C(C(C)(C)C)C1=O]

For the electron transport materials used in Examples 2 to 30 and Comparative Examples 1 to 11, the solubility S_{ETM} (THF) of the azoquinone derivative having a structure represented by the above structural formula (ET1-5) was 1 (g); the solubility S_{ETM} (THF) of the azoquinone derivative having a structure represented by the above structural formula (ET1-3) was 1 (g) or less; the solubility S_{ETM} (THF) of the azoquinone derivative having a structure represented by the above structural formula (ET-1) was 3 (g); the solubility S_{ETM} (THF) of the azoquinone derivative having a structure represented by the above structural formula (ET-2) was 15 (g); and the solubility S_{ETM} (THF) of the azoquinone derivative having a structure represented by the above structural formula (ET-3) was 22 (g).

TABLE 1

| | charge transport layer | | | | | charge generation layer | | | | | | | | | | |
|---|---|---|---|---|---|---|---|---|---|---|---|---|---|---|---|---|
| | first hole | | | | | charge | | second hole | | first electron | | second electron | | | | |
| | transport | | | | | generation | | transport | | transport | | transport | | | | |
| | material | | resin binder | | | material | | material | | material | | material | | resin binder | | |
| | | con- | | con- | | | con- | | con- | | con- | | con- | | con- | |
| | | tent | | tent | thick- | | tent | | tent | | tent | | tent | | tent | thick- |
| | mate- | (mass | mate- | (mass | ness | mate- | (mass | mate- | (mass | mate- | (mass | mate- | (mass | mate- | (mass | ness |
| | rial | %) | rial | %) | (μm) | rial | %) | rial | %) | rial | %) | rial | %) | rial | %) | (μm) |
| Ex. 1 | HT1-5 | 60 | GB1-1 | 40 | 10 | CG1 | 1.5 | HT1-5 | 6.4 | ET1-4 | 57.6 | ET2-4 | 0 | GB1-2 | 34.5 | 15 |
| Ex. 2 | HT1-5 | 60 | GB1-1 | 40 | 10 | CG1 | 1.5 | HT1-5 | 6.4 | ET1-4 | 34.6 | ET2-4 | 23 | GB1-2 | 34.5 | 15 |
| Ex. 3 | HT1-5 | 60 | GB1-1 | 40 | 10 | CG1 | 1.5 | HT1-5 | 6.4 | ET1-4 | 23 | ET2-4 | 34.6 | GB1-2 | 34.5 | 15 |
| Ex. 4 | HT-1 | 50 | GB1-2 | 50 | 15 | CG1 | 1.5 | HT1-5 | 9.8 | ET1-4 | 49.2 | ET2-4 | 0 | GB1-3 | 39.5 | 10 |
| Ex. 5 | HT-1 | 50 | GB1-2 | 50 | 15 | CG1 | 1.5 | HT1-5 | 9.8 | ET1-4 | 295 | ET2-4 | 19.7 | GB1-3 | 39.5 | 10 |
| Ex. 6 | HT-1 | 50 | GB1-2 | 50 | 15 | CG1 | 1.5 | HT1-5 | 9.8 | ET1-4 | 19.7 | ET2-4 | 29.5 | GB1-3 | 39.5 | 10 |
| Ex. 7 | HT-2 | 40 | GB1-3 | 60 | 12.5 | CG1 | 1.5 | HT-1 | 18 | ET1-4 | 36 | ET2-4 | 0 | GB1-3 | 44.5 | 12.5 |
| Ex. 8 | HT-2 | 40 | GB1-3 | 60 | 12.5 | CG1 | 1.5 | HT-1 | 18 | ET1-4 | 21.6 | ET2-4 | 14.4 | GB1-3 | 44.5 | 12.5 |
| Ex. 9 | HT-2 | 40 | GB1-3 | 60 | 12.5 | CG1 | 1.5 | HT-1 | 18 | ET1-4 | 14.4 | ET2-4 | 21.6 | GB1-3 | 44.5 | 12.5 |
| Ex. 10 | HT-2 | 60 | GB1-1 | 40 | 10 | CG1 | 2.5 | HT-2 | 5.8 | ET1-5 | 52.2 | ET2-4 | 0 | GB1-3 | 39.5 | 20 |
| Ex. 11 | HT-2 | 60 | GB1-1 | 40 | 10 | CG1 | 2.5 | HT-2 | 5.8 | ET1-5 | 31.3 | ET2-4 | 20.9 | GB1-3 | 39.5 | 20 |
| Ex. 12 | HT-2 | 60 | GB1-1 | 40 | 10 | CG1 | 2.5 | HT-2 | 5.8 | ET1-5 | 20.9 | ET2-4 | 31.3 | GB1-3 | 39.5 | 20 |
| Ex. 13 | HT-3 | 50 | GB1-2 | 50 | 15 | CG1 | 2.5 | HT-3 | 8.8 | ET1-5 | 43.8 | ET2-4 | 0 | GB1-2 | 45 | 15 |
| Ex. 14 | HT-3 | 50 | GB1-2 | 50 | 15 | CG1 | 2.5 | HT-3 | 8.8 | ET1-5 | 26.3 | ET2-4 | 17.5 | GB1-2 | 45 | 15 |

TABLE 2

| | charge transport layer | | | | | charge generation layer | | | | | | | | | | |
|---|---|---|---|---|---|---|---|---|---|---|---|---|---|---|---|---|
| | first hole | | | | | charge | | second hole | | first electron | | second electron | | | | |
| | transport | | | | | generation | | transport | | transport | | transport | | | | |
| | material | | resin binder | | | material | | material | | material | | material | | resin binder | | |
| | | con- | | con- | | | con- | | con- | | con- | | con- | | con- | |
| | | tent | | tent | thick- | | tent | | tent | | tent | | tent | | tent | thick- |
| | mate- | (mass | mate- | (mass | ness | mate- | (mass | mate- | (mass | mate- | (mass | mate- | (mass | mate- | (mass | ness |
| | rial | %) | rial | %) | (μm) | rial | %) | rial | %) | rial | %) | rial | %) | rial | %) | (μm) |
| Ex. 15 | HT-3 | 50 | GB1-2 | 50 | 15 | CG1 | 2.5 | HT-3 | 8.8 | ET1-5 | 17.5 | ET2-4 | 26.3 | GB1-2 | 45 | 15 |
| Ex. 16 | HT-4 | 40 | GB1-3 | 60 | 20 | CG1 | 2.5 | HT-4 | 16 | ET1-5 | 32 | ET2-4 | 0 | GB1-1 | 49.5 | 10 |
| Ex. 17 | HT-4 | 40 | GB1-3 | 60 | 20 | CG1 | 2.5 | HT-4 | 16 | ET1-5 | 19.2 | ET2-4 | 128 | GB1-1 | 49.5 | 10 |
| Ex. 18 | HT-4 | 40 | GB1-3 | 60 | 20 | CG1 | 2.5 | HT-4 | 16 | ET1-5 | 12.8 | ET2-4 | 19.2 | GB1-1 | 49.5 | 10 |
| Ex. 19 | HT1-5 | 60 | GB1-1 | 40 | 10 | CG1 | 1.5 | HT1-5 | 9.8 | ET1-4 | 19 | ET2-4 | 30.2 | GB1-2 | 39.5 | 15 |
| Ex. 20 | HT1-5 | 60 | GB1-1 | 40 | 10 | CG1 | 1.5 | HT1-5 | 9.8 | ET1-4 | 11.2 | ET2-4 | 38 | GB1-2 | 39.5 | 15 |
| Com. Ex. 1 | HT1-5 | 60 | GB1-1 | 40 | 10 | CG1 | 1.5 | HT1-5 | 9.8 | ET1-4 | 0 | ET2-4 | 49.2 | GB1-2 | 39.5 | 15 |
| Ex. 21 | HT-1 | 50 | GB1-2 | 50 | 15 | CG1 | 1.5 | HT-1 | 9.8 | ET1-5 | 19 | ET2-4 | 30.2 | GB1-2 | 39.5 | 15 |
| Ex. 22 | HT-1 | 50 | GB1-2 | 50 | 15 | CG1 | 1.5 | HT-1 | 9.8 | ET1-5 | 11.2 | ET2-4 | 38 | GB1-2 | 39.5 | 15 |
| Com. Ex. 2 | HT-1 | 50 | GB1-2 | 50 | 15 | CG1 | 1.5 | HT-1 | 9.8 | ET1-5 | 0 | ET2-4 | 49.2 | GB1-2 | 39.5 | 15 |
| Com. Ex. 3 | HT-2 | 60 | GB1-1 | 40 | 10 | CG1 | 1.5 | HT-2 | 9.8 | ET-1 | 49.2 | ET2-4 | 0 | GB1-3 | 39.5 | 15 |
| Com. Ex. 4 | HT-2 | 60 | GB1-1 | 40 | 10 | CG1 | 1.5 | HT-2 | 9.8 | ET-1 | 29.5 | ET2-4 | 19.7 | GB1-3 | 39.5 | 15 |
| Com. Ex. 5 | HT-2 | 60 | GB1-1 | 40 | 10 | CG1 | 1.5 | HT-2 | 9.8 | ET-1 | 19.7 | ET2-4 | 29.5 | GB1-3 | 39.5 | 15 |

TABLE 3

| | charge transport layer | | | | | charge generation layer | | | | | | | | | | |
|---|---|---|---|---|---|---|---|---|---|---|---|---|---|---|---|---|
| | first hole | | | | | charge | | second hole | | first electron | | second electron | | | | |
| | transport | | | | | generation | | transport | | transport | | transport | | | | |
| | material | | resin binder | | | material | | material | | material | | material | | resin binder | | |
| | | con- | | con- | | | con- | | con- | | con- | | con- | | con- | |
| | | tent | | tent | thick- | | tent | | tent | | tent | | tent | | tent | thick- |
| | mate- | (mass | mate- | (mass | ness | mate- | (mass | mate- | (mass | mate- | (mass | mate- | (mass | mate- | (mass | ness |
| | rial | %) | rial | %) | (μm) | rial | %) | rial | %) | rial | %) | rial | %) | rial | %) | (μm) |
| Ex. 23 | HT-3 | 45 | GB1-1 | 55 | 10 | CG1 | 2 | HT1-5 | 9.7 | ET1-3 | 48.3 | ET2-4 | 0 | GB1-3 | 40 | 20 |
| Ex. 24 | HT-3 | 45 | GB1-1 | 55 | 10 | CG1 | 2 | HT1-5 | 9.7 | ET1-3 | 29 | ET2-4 | 19.3 | GB1-3 | 40 | 20 |
| Ex. 25 | HT-3 | 45 | GB1-1 | 55 | 10 | CG1 | 2 | HT1-5 | 9.7 | ET1-3 | 19.3 | ET2-4 | 29 | GB1-3 | 40 | 20 |
| Com. Ex. 6 | HT1-5 | 45 | GB1-1 | 55 | 10 | CG1 | 2 | HT1-5 | 9.7 | ET-2 | 48.3 | ET2-4 | 0 | GB1-3 | 40 | 20 |
| Com. Ex. 7 | HT1-5 | 45 | GB1-1 | 55 | 10 | CG1 | 2 | HT1-5 | 9.7 | ET-2 | 29 | ET2-4 | 19.3 | GB1-3 | 40 | 20 |
| Com. Ex. 8 | HT1-5 | 45 | GB1-1 | 55 | 10 | CG1 | 2 | HT1-5 | 9.7 | ET-2 | 19.3 | ET2-4 | 29 | GB1-3 | 40 | 20 |
| Com. Ex. 9 | HT1-5 | 45 | GB1-1 | 55 | 10 | CG1 | 2 | HT1-5 | 9.7 | ET-3 | 48.3 | ET2-4 | 0 | GB1-3 | 40 | 20 |
| Com. Ex. 10 | HT1-5 | 45 | GB1-1 | 55 | 10 | CG1 | 2 | HT1-5 | 9.7 | ET-3 | 29 | ET2-4 | 19.3 | GB1-3 | 40 | 20 |
| Com. Ex. 11 | HT1-5 | 45 | GB1-1 | 55 | 10 | CG1 | 2 | HT1-5 | 9.7 | ET-3 | 19.3 | ET2-4 | 29 | GB1-3 | 40 | 20 |
| Ex. 26 | HT1-5 | 60 | GB1-1 | 40 | 10 | CG1 | 1.5 | HT1-5 | 6.4 | ET1-4 | 34.6 | ET-1 | 23 | GB1-2 | 34.5 | 15 |
| Ex. 27 | HT1-5 | 60 | GB1-1 | 40 | 10 | CG1 | 1.5 | HT1-5 | 6.4 | ET1-5 | 34.6 | ET-1 | 23 | GB1-2 | 34.5 | 15 |
| Ex. 28 | HT1-5 | 60 | GB1-1 | 40 | 10 | CG1 | 15 | HT1-5 | 6.4 | ET1-4 | 34.6 | ET2-5 | 23 | GB1-2 | 34.5 | 15 |
| Ex. 29 | HT1-5 | 60 | GB1-1 | 40 | 10 | CG1 | 1.5 | HT1-5 | 6.4 | ET1-5 | 34.6 | ET2-5 | 23 | GB1-2 | 34.5 | 15 |
| Ex. 30 | HT-3 | 45 | GB1-1 | 55 | 10 | CG1 | 2 | HT1-5 | 9.7 | ET1-1 | 48.3 | — | 0 | GB1-3 | 40 | 20 |

### (Evaluation of Liquid State)

### [Evaluation of Solubility]

For the photoconductors obtained from Examples and Comparative Examples, the amount of a tetrahydrofuran (THF) solvent required to dissolve 1 g of an electron transport material to be used (when a plurality of electron transport agents were used, the total amount was 1 g after proportional division based on the ratio) was measured and evaluated as follows: □ for 2 g or less, ∘ for more than 2 g and 5 g or less, Δ for more than 5 g and 20 g or less, and x for more than 20 g.

### [Evaluation of Precipitate]

The photoconductors obtained from Examples and Comparative Examples were observed visually and under an optical microscope for precipitates of the electron transport material in the formation of the charge generation layer, and evaluated as follows: ∘ for no precipitate found (the size of the precipitate was less than 1 μm), Δ for precipitates with a size of 1 μm or more and less than 50 μm, x for precipitates with a size of 50 μm or more.

### [Evaluation of Particle Size]

The photoconductors obtained from Examples and Comparative Examples were evaluated for the presence of coarse particles in the coating solution by measuring the median diameter D50. Specifically, the coating solution for the charge generation layer was diluted 20 times with the solvent THF, and measured using a dynamic light scattering particle size distribution analyzer LB-500 (manufactured by HORIBA, Ltd.). The evaluations criteria were as follows: ∘ for median diameter D50≤400 nm, Δ for 400 nm<D50≤500 nm, and x for D50>500 nm.

### (Evaluation of Electrical Characteristics)

### [Evaluation of Sensitivity]

The photoconductors obtained from Examples and Comparative Examples were installed in the yellow, cyan, magenta, and black (four colors) toners of a tandem color printer with a printing speed of 31 ppm (HL-9310CDW, Brother Industries, Ltd.). The potential after exposure with the actual apparatus was measured at a temperature of 25° C. and a humidity of 40%, and the average value was evaluated as follows: □ for less than 120 V, ∘ for 120 V or more and less than 140 V, Δ for 140 V or more and less than 160 V, and x for 160 V or more.

### [Evaluation of Potential Stability]

The photoconductors obtained from Examples and Comparative Examples were installed in the four-color toners of a tandem color printer with a printing speed of 31 ppm (HL-9310CDW, Brother Industries, Ltd.). The decrease in charge potential after printing 50 k sheets was measured at a temperature of 10° C. and a humidity of 25%, and the average value was evaluated as follows: □ for less than 30 V, ∘ for 30 V or more and less than 50 V, Δ for 50 V or more and less than 80 V, and x for 80 V or more.

### (Evaluation of Image Characteristics)

### [Evaluation of Gradation]

The photoconductors obtained from Examples and Comparative Examples were installed in the four-color toners of a tandem color printer with a printing speed of 31 ppm (HL-9310CDW, Brother Industries, Ltd.). Images were printed using four monochromatic colors with 10 levels of area gradation ranging from low to high density, and the print density at each tone was measured with a density meter (Gretag Macbeth RD-191). The density difference between one tone and the tone before/after it was considered as follows: ∘ for 0.05 or more, Δ for 0.02 or more and less than 0.05, and x for less than 0.02.

### [Evaluation of Ghost Image]

The photoconductors obtained from Examples and Comparative Examples were installed in the four-color toners of a tandem color printer with a printing speed of 31 ppm (HL-9310CDW, Brother Industries, Ltd.). A solid image was printed using four monochromatic colors, and an intermediate tone (1 on 2 off image) was printed after an interval of one round of the photoconductor in the solid image section. The difference in printing density between the intermediate tone section and the ghost section of the solid image appearing in the intermediate tone section was measured. The density difference was considered as follows: ∘ for less than 0.02, Δ for 0.02 or more and less than 0.05, and x for 0.05 or more.

The evaluation results are shown in the following Tables 4 and 5. When a first electron transport material is compared among compounds represented by the structural formulae (ET1-1), (ET1-3), (ET1-4), and (ET1-5), the results of Examples 4, 13, 23, and 30 show that the position of a chlorine atom in the general formula (ET1) is preferably at least one of R⁴ and R⁸. In particular, when the first electron transport material is a compound represented by the structural formula (ET1-4) or (ET1-5), a comparison of Examples 1 to 3, 4 to 6, 7 to 9, 10 to 12, 13 to 15, and 16 to 18 shows that potential stability is improved when a second electron transport material is added.

TABLE 4

| | evaluation result | | | | | | |
|---|---|---|---|---|---|---|---|
| | liquid state | | | electrical characteristics | | | |
| | | | particle | | potential | image characteristics | |
| | solubility | precipitate | size | sensitivity | stability | gradation | ghost |
| Ex. 1 | □ | ∘ | ∘ | □ | ∘ | ∘ | ∘ |
| Ex. 2 | ∘ | ∘ | ∘ | □ | □ | ∘ | ∘ |
| Ex. 3 | □ | ∘ | ∘ | ∘ | □ | ∘ | ∘ |
| Ex. 4 | □ | ∘ | ∘ | □ | ∘ | ∘ | ∘ |
| Ex. 5 | ∘ | ∘ | ∘ | ∘ | □ | ∘ | ∘ |
| Ex. 6 | □ | ∘ | ∘ | ∘ | □ | ∘ | ∘ |
| Ex. 7 | □ | ∘ | ∘ | □ | ∘ | ∘ | ∘ |
| Ex. 8 | ∘ | ∘ | ∘ | ∘ | □ | ∘ | ∘ |
| Ex. 9 | □ | ∘ | ∘ | ∘ | ∘ | ∘ | ∘ |
| Ex. 10 | ∘ | ∘ | ∘ | ∘ | ∘ | ∘ | ∘ |
| Ex. 11 | ∘ | ∘ | ∘ | ∘ | ∘ | ∘ | ∘ |
| Ex. 12 | ∘ | ∘ | ∘ | ∘ | □ | ∘ | ∘ |
| Ex. 13 | ∘ | ∘ | ∘ | ∘ | ∘ | ∘ | ∘ |
| Ex. 14 | ∘ | ∘ | ∘ | ∘ | ∘ | ∘ | ∘ |
| Ex. 15 | ∘ | ∘ | ∘ | ∘ | □ | ∘ | ∘ |
| Ex. 16 | ∘ | ∘ | ∘ | ∘ | ∘ | ∘ | ∘ |
| Ex. 17 | ∘ | ∘ | ∘ | ∘ | □ | ∘ | ∘ |
| Ex. 18 | ∘ | ∘ | ∘ | ∘ | □ | ∘ | ∘ |
| Ex. 19 | ∘ | ∘ | ∘ | Δ | Δ | Δ | Δ |
| Ex. 20 | ∘ | ∘ | ∘ | Δ | Δ | Δ | Δ |
| Com. Ex. 1 | ∘ | ∘ | ∘ | Δ | Δ | Δ | x |
| Ex. 21 | ∘ | ∘ | ∘ | Δ | Δ | Δ | Δ |
| Ex. 22 | ∘ | ∘ | ∘ | Δ | Δ | Δ | Δ |

TABLE 5

| | evaluation result | | | | | | |
|---|---|---|---|---|---|---|---|
| | | | | electrical | | | |
| | liquid state | | | characteristics | | image | |
| | | | particle | | potential | characteristics | |
| | solubility | precipitate | size | sensitivity | stability | gradation | ghost |
| Com. Ex. 2 | ∘ | ∘ | ∘ | Δ | Δ | Δ | x |
| Com. Ex. 3 | x | x | x | x | x | x | x |
| Com. Ex. 4 | Δ | Δ | Δ | x | Δ | x | Δ |
| Com. Ex. 5 | ∘ | ∘ | ∘ | Δ | Δ | x | Δ |
| Ex. 23 | □ | ∘ | ∘ | Δ | Δ | Δ | Δ |
| Ex. 24 | □ | ∘ | ∘ | Δ | ∘ | Δ | Δ |
| Ex. 25 | □ | ∘ | ∘ | Δ | ∘ | Δ | Δ |
| Com. Ex. 6 | x | x | x | x | x | x | x |
| Com. Ex. 7 | x | x | x | x | x | x | x |
| Com. Ex. 8 | x | x | x | x | x | x | x |
| Com. Ex. 9 | x | x | x | x | x | x | x |
| Com. Ex. 10 | x | x | x | x | x | x | x |
| Com. Ex. 11 | x | x | x | x | x | x | x |
| Ex. 26 | ∘ | ∘ | ∘ | □ | ∘ | ∘ | ∘ |
| Ex. 27 | ∘ | ∘ | ∘ | ∘ | ∘ | ∘ | ∘ |
| Ex. 28 | ∘ | ∘ | ∘ | □ | ∘ | ∘ | ∘ |
| Ex. 29 | ∘ | ∘ | ∘ | ∘ | ∘ | ∘ | ∘ |
| Ex. 30 | Δ | ∘ | Δ | Δ | Δ | Δ | Δ |

### <Single-Layer Photoconductor>

### Example 31

A 0.75 mm wall thickness tube made of aluminum, machined to φ30 mm×244.5 mm length and surface roughness (Rmax) of 0.2 μm, was used as a conductive substrate. The conductive substrate had an anodized layer on the surface.

### [Single-Layer Photosensitive Layer]

According to the compounding amounts shown in Table 6 below, the compound represented by the structural formula (HT1-5) as the hole transport material, the compound represented by the structural formula (ET1-3) as the electron transport material, and the polycarbonate resin having the repeating unit shown in the structural formula (GB1-1) as the resin binder were dissolved in tetrahydrofuran, after adding the titanyl phthalocyanine shown in the above structural formula (CG1) as the charge generating material, a coating solution was prepared by performing a dispersion treatment with a disperser (DYNO-MILL Research Lab type manufactured by Willy A. Bachofen AG) under the conditions of beads: φ 0.4 ZrO, filling ratio: 60%, rotation speed: 3600 rpm, and 4 passes. The coating solution was applied to the anodized layer by dip coating and dried at 100° C. for 60 minutes to form a single-layer photosensitive layer with a thickness of 30 μm to obtain a positively charged single-layer photoconductor for electrophotography.

### Examples 32 to 38 and Comparative Examples 12 to 16

Positively charged single-layer photoconductors for electrophotography were obtained in the same manner as in Example 31 except that the types and amounts of materials were changed according to the conditions shown in Table 6 below.

TABLE 6

| | single-layer photosensitive layer | | | | | | | | | | |
|---|---|---|---|---|---|---|---|---|---|---|---|
| | charge | | | | first electron | | second electron | | | | |
| | generation | | hole transport | | transport | | transport | | | | |
| | material | | material | | material | | material | | resin binder | | thick- |
| | | content | | content | | content | | content | | content | ness |
| | material | (mass %) | material | (mass %) | material | (mass %) | material | (mass %) | material | (mass %) | (μm) |
| Ex. 31 | CG1 | 1.3 | HT1-5 | 30 | ET1-3 | 18.7 | — | 0.0 | GB1-1 | 50 | 30 |
| Ex. 32 | CG1 | 1.3 | HT1-5 | 30 | ET1-3 | 10.3 | ET2-4 | 8.4 | GB1-1 | 50 | 30 |
| Ex. 33 | CG1 | 1.3 | HT1-5 | 30 | ET1-4 | 18.7 | — | 0.0 | GB1-1 | 50 | 30 |
| Ex. 34 | CG1 | 1.3 | HT1-5 | 30 | ET1-4 | 10.3 | ET2-4 | 8.4 | GB1-1 | 50 | 30 |
| Ex. 35 | CG1 | 1.3 | HT1-5 | 30 | ET1-5 | 18.7 | — | 0.0 | GB1-1 | 50 | 30 |
| Ex. 36 | CG1 | 1.3 | HT1-5 | 30 | ET1-5 | 10.3 | ET2-4 | 8.4 | GB1-1 | 50 | 30 |
| Ex. 37 | CG1 | 1.3 | HT1-5 | 30 | ET1-1 | 18.7 | — | 0.0 | GB1-1 | 50 | 30 |
| Ex. 38 | CG1 | 1.3 | HT1-5 | 30 | ET1-1 | 10.3 | ET2-4 | 8.4 | GB1-1 | 50 | 30 |
| Com. Ex. 12 | CG1 | 1.3 | HT1-5 | 30 | ET1-1 | 18.7 | — | 0.0 | GB1-1 | 50 | 30 |
| Com. Ex. 13 | CG1 | 1.3 | HT1-5 | 30 | ET1-1 | 10.3 | ET2-4 | 8.4 | GB1-1 | 50 | 30 |
| Com. Ex. 14 | CG1 | 1.3 | HT1-5 | 30 | ET1-2 | 18.7 | — | 0.0 | GB1-1 | 50 | 30 |
| Com. Ex. 15 | CG1 | 1.3 | HT1-5 | 30 | ET1-2 | 10.3 | ET2-4 | 8.4 | GB1-1 | 50 | 30 |
| Com. Ex. 16 | CG1 | 1.3 | HT1-5 | 30 | — | 0.0 | ET2-4 | 18.7 | GB1-1 | 50 | 30 |

### (Evaluation of Liquid State)

### [Evaluation of Precipitate]

The photoconductors obtained from Examples and Comparative Examples were observed visually and under an optical microscope for precipitates of the electron transport material in the formation of the single-layer photosensitive layer, and evaluated as follows: ∘ for no precipitate found (the size of the precipitate was less than 1 μm), Δ for precipitates with a size of 1 μm or more and less than 50 μm, x for precipitates with a size of 50 μm or more.

### [Evaluation of Particle Size]

The photoconductors obtained from Examples and Comparative Examples were evaluated for the presence of coarse particles in the coating solution by measuring the median diameter D50. Specifically, the coating solution for the single-layer photosensitive layer was diluted 20 times with the solvent THF and measured using a dynamic light scattering particle size distribution analyzer LB-500 (manufactured by HORIBA, Ltd.). The evaluations were performed as follows: ∘ for median diameter D50≤400 nm, Δ for 400 nm<D50≤500 nm, and x for D50>500 nm.

### (Evaluation of Electrical Characteristics)

### [Evaluation of Sensitivity]

The photoconductors obtained from Examples and Comparative Examples were installed in a monochrome printer with a printing speed of 40 ppm (HL-5200DW, Brother Industries, Ltd.). The potential after exposure with the actual apparatus was measured at a temperature of 25° C. and a humidity of 40%, and the average value was evaluated as follows: □ for less than 120 V, ∘ for 120 V or more and less than 140 V, Δ for 140 V or more and less than 160 V, and x for 160 V or more.

### [Evaluation of Potential Stability]

The photoconductors obtained from Examples and Comparative Examples were installed in a monochrome printer with a printing speed of 40 ppm (HL-5200DW, Brother Industries, Ltd.). The decrease in charge potential after printing 50 k sheets was measured at a temperature of 10° C. and a humidity of 25%, and the average value was evaluated as follows: □ for less than 30 V, ∘ for 30 V or more and less than 50 V, Δ for 50 V or more and less than 80 V, and x for 80 V or more.

The evaluation results are shown in the following Table 7. When a first electron transport material is compared among compounds represented by the structural formulae (ET1-1), (ET1-3), (ET1-4), and (ET1-5), the results of Examples 31, 33, 35, and 37 show, as with the multi-layer type, that the position of a chlorine atom in the general formula (ET1) is preferably at least one of R⁴ and R⁸. In particular, when the first electron transport material is a compound represented by the structural formula (ET1-4) or (ET1-5), a comparison of Examples 33 to 36 shows that potential stability is improved when a second electron transport material is added.

TABLE 7

| | evaluation results | | | |
|---|---|---|---|---|
| | liquid state | | electrical characteristics | |
| | precipitate | particle size | sensitivity | potential stability |
| Ex. 31 | ∘ | ∘ | □ | ∘ |
| Ex. 32 | ∘ | ∘ | □ | ∘ |
| Ex. 33 | ∘ | ∘ | □ | ∘ |
| Ex. 34 | ∘ | ∘ | □ | □ |
| Ex. 35 | ∘ | ∘ | □ | ∘ |
| Ex. 36 | ∘ | ∘ | □ | □ |
| Ex. 37 | ∘ | ∘ | ∘ | ∘ |
| Ex. 38 | ∘ | ∘ | ∘ | ∘ |
| Com. Ex. 12 | ∘ | ∘ | ∘ | × |
| Com. Ex. 13 | ∘ | ∘ | □ | × |
| Com. Ex. 14 | Δ | × | × | × |
| Com. Ex. 15 | ∘ | ∘ | Δ | × |
| Com. Ex. 16 | ∘ | ∘ | Δ | Δ |

These results confirmed that the use of an electron transport material that satisfies the conditions according to the present invention allows for obtaining a photoconductor for electrophotography that has sufficiently high sensitivity and excellent potential stability during repeated printing in various environments, and does not cause problems such as deterioration of gradation or generation of memory images.

### DESCRIPTION OF SYMBOLS

1 conductive substrate
2 undercoat layer
3 single-layer photosensitive layer
4 charge transport layer
5 charge generation layer
6 photosensitive layer
20 photoconductor
21 charger
22 high-voltage power supply
23 exposure
24 developer
25 transfer
26 cleaner
30 electrophotographic equipment

1. A positively-charged photoconductor for electrophotography, comprising:
a conductive substrate; and
a photosensitive layer formed on the conductive substrate,
wherein the photosensitive layer contains electron transport materials, and
wherein at least one of the electron transport materials contains an azoquinone derivative having a structure represented by the following general formula (ET1): 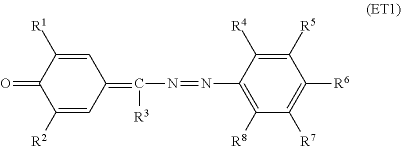
wherein,
R¹ and R² are the same or different and each represent a hydrogen atom, a C₁₋₁₂ alkyl group, a C₁₋₁₂ alkoxy group, an optionally substituted aryl group, a cycloalkyl group, an optionally substituted aralkyl group, or a halogenated alkyl group,
R³ represents a hydrogen atom, a C₁₋₆ alkyl group, a C₁₋₆ alkoxy group, an optionally substituted aryl group, a cycloalkyl group, an optionally substituted aralkyl group, or a halogenated alkyl group,
at least two of R⁴ to R⁸ represent chlorine atoms; and the remaining R⁴ to R⁸ other than those representing chlorine atoms are the same or different, and each represent a hydrogen atom, a halogen atom other than chlorine atom, a C₁₋₁₂ alkyl group, a C₁₋₁₂ alkoxy group, an optionally substituted aryl group, an optionally substituted aralkyl group, an optionally substituted phenoxy group, a halogenated alkyl group, a cyano group, or a nitro group, and
the substituent represents a halogen atom, a C₁₋₆ alkyl group, a C₁₋₆ alkoxy group, a hydroxy group, a cyano group, an amino group, a nitro group, or a halogenated alkyl group.

2. The positively-charged photoconductor for electrophotography according to claim 1, wherein at least one of R⁴ and R⁸ represents a chlorine atom.

3. The positively-charged photoconductor for electrophotography according to claim 1, wherein
R¹ and R² each represent a tert-butyl group, and
R³ represents a hydrogen atom.

4. The positively-charged photoconductor for electrophotography according to claim 1, wherein the solubility S_{ETM} (THF) of the azoquinone derivative having a structure represented by the general formula (ET1) (the mass (g) of tetrahydrofuran required to dissolve 1 g of the azoquinone derivative) satisfies the following inequality:
S_{ETM}(THF)≤2.0.

5. The positively-charged photoconductor for electrophotography according to claim 1, wherein the azoquinone derivative having a structure represented by the general formula (ET1) is represented by the following structural formula (ET1-4) or (ET1-5):

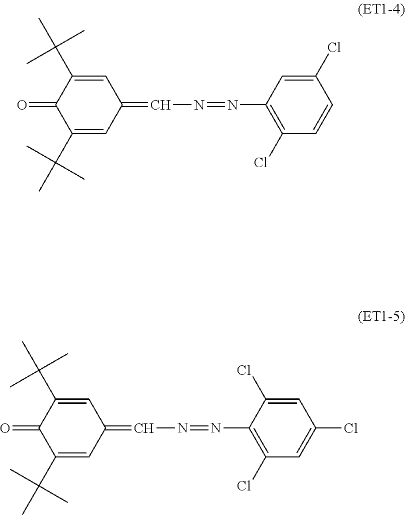

6. The positively-charged photoconductor for electrophotography according to claim 5, wherein the electron transport materials further contain a naphthalenetetracarboxdiimide compound having a structure represented by the following general formula (ET2): 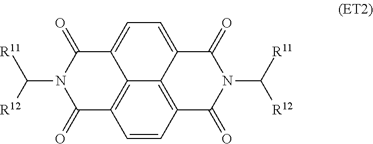
wherein, R¹¹ and R¹² are the same or different and each represent a hydrogen atom, a C₁₋₁₀ alkyl group, an alkylene group, an alkoxy group, an alkyl ester group, an optionally substituted phenyl group, an optionally substituted naphthyl group, or a halogen atom, and R¹¹ and R¹² are optionally linked together to form an optionally substituted aromatic ring.

7. The positively-charged photoconductor for electrophotography according to claim 5, wherein the electron transport materials further contain a compound having a structure represented by the following structural formula (ET-1):

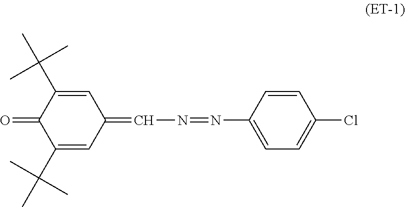 [SMILES: CC(C)(C)C1=CC(=CN=Nc2ccc(Cl)cc2)C=C(C(C)(C)C)C1=O]

8. The positively-charged photoconductor for electrophotography according to claim 1,
wherein the photosensitive layer is a multi-layer type comprising, in sequence, a charge transport layer and a charge generation layer, and
wherein the charge generation layer contains the electron transport materials.

9. The positively-charged photoconductor for electrophotography according to claim 1, wherein the photosensitive layer is a single-layer type including the electron transport materials.

10. A method of manufacturing the positively-charged photoconductor for electrophotography according to claim 1, comprising the steps of:
preparing a photosensitive layer coating solution containing an azoquinone derivative having a structure represented by the general formula (ET1); and
forming the photosensitive layer by dip coating using the photosensitive layer coating solution.

11. An electrophotographic equipment comprising the positively-charged photoconductor for electrophotography according to claim 1.
